(19) United States
(12) Patent Application Publication
(10) Pub. No.: US 2026/0040161 A1
(43) Pub. Date: Feb. 5, 2026

(54) MOBILITY MANAGEMENT IN WIRELESS COMMUNICATION SYSTEM

(71) Applicant: LG ELECTRONICS INC., Seoul (KR)

(72) Inventor: Sunghoon JUNG, Seoul (KR)

(73) Assignee: LG ELECTRONICS INC., Seoul (KR)

(21) Appl. No.: 19/101,506

(22) PCT Filed: Aug. 8, 2023
(86) PCT No.: PCT/KR2023/011662

§ 371 Date: Feb. 5, 2025

Related U.S. Application Data
(60) Provisional application No. 63/396,590, filed on Aug. 9, 2022.

(51) Int. Cl. H04W 36/00; H04W 36/08

(52) U.S. Cl. CPC H04W 36/0079; H04W 36/0077; H04W 36/08

(57) ABSTRACT

The present disclosure relates to a mobility management in wireless communications. According to an embodiment of the present disclosure, a method performed by a user equipment (UE) in a wireless communication system comprises: receiving, from a network node, a radio resource control (RRC) message comprising access configurations for one or more target cells; receiving, from the network node, an indication, wherein the indication comprises access information; and performing an access to a target cell based on an access configuration for the target cell in the RRC message and the access information in the indication, wherein the access information comprises at least one of a random access preamble for the access or a target cell information for the access, and wherein the target cell information i) informs a cell identifier (ID) of a target cell not included in the one or more target cells configured for the UE, or ii) does not inform any cell ID.

### CROSS-REFERENCE TO RELATED APPLICATION(S)

This application is the National Stage filing under 35 U.S.C. 371 of International Application No. PCT/KR2023/011662, filed on Aug. 8, 2023, which claims the benefit of U.S. Provisional Application No. 63/396,590, filed on Aug. 9, 2022, the contents of which are all hereby incorporated by reference herein in their entireties.

### TECHNICAL FIELD

The present disclosure relates to a mobility management in wireless communications.

### BACKGROUND

3rd Generation Partnership Project (3GPP) Long-Term Evolution (LTE) is a technology for enabling high-speed packet communications. Many schemes have been proposed for the LTE objective including those that aim to reduce user and provider costs, improve service quality, and expand and improve coverage and system capacity. The 3GPP LTE requires reduced cost per bit, increased service availability, flexible use of a frequency band, a simple structure, an open interface, and adequate power consumption of a terminal as an upper-level requirement.

Work has started in International Telecommunication Union (ITU) and 3GPP to develop requirements and specifications for New Radio (NR) systems. 3GPP has to identify and develop the technology components needed for successfully standardizing the new RAT timely satisfying both the urgent market needs, and the more long-term requirements set forth by the ITU Radio communication sector (ITU-R) International Mobile Telecommunications (IMT)-2020 process. Further, the NR should be able to use any spectrum band ranging at least up to 100 GHz that may be made available for wireless communications even in a more distant future.

The NR targets a single technical framework addressing all usage scenarios, requirements and deployment scenarios including enhanced Mobile BroadBand (eMBB), massive Machine Type Communications (mMTC), Ultra-Reliable and Low Latency Communications (URLLC), etc. The NR shall be inherently forward compatible.

In wireless communications, a user equipment (UE) may perform a mobility from a source cell to a target cell. For the mobility, the UE may be configured with one or more cell configurations, and may perform the mobility to a target cell based on applying a cell configuration for the target cell. In some implementations, the UE may need to perform a mobility in integrated access and backhaul (IAB) network. For example, when a UE is connected to an JAB node and the JAB node has failed to migrate to another JAB node, the UE may need to perform the mobility.

### SUMMARY

An aspect of the present disclosure is to provide method and apparatus for a mobility management in a wireless communication system.

Another aspect of the present disclosure is to provide method and apparatus for a mobility management in IAB networks in a wireless communication system.

According to an embodiment of the present disclosure, a method performed by a user equipment (UE) in a wireless communication system comprises: receiving, from a network node, a radio resource control (RRC) message comprising access configurations for one or more target cells; receiving, from the network node, an indication, wherein the indication comprises access information; and performing an access to a target cell based on an access configuration for the target cell in the RRC message and the access information in the indication, wherein the access information comprises at least one of a random access preamble for the access or a target cell information for the access, and wherein the target cell information i) informs a cell identifier (ID) of a target cell not included in the one or more target cells configured for the UE, or ii) does not inform any cell ID.

According to an embodiment of the present disclosure, a user equipment (UE) configured to operate in a wireless communication system comprises: at least one transceiver; at least one processor; and at least one memory operatively coupled to the at least one processor and storing instructions that, based on being executed by the at least one processor, perform operations comprising: receiving, from a network node, a radio resource control (RRC) message comprising access configurations for one or more target cells; receiving, from the network node, an indication, wherein the indication comprises access information; and performing an access to a target cell based on an access configuration for the target cell in the RRC message and the access information in the indication, wherein the access information comprises at least one of a random access preamble for the access or a target cell information for the access, and wherein the target cell information i) informs a cell ID of a target cell not included in the one or more target cells configured for the UE, or ii) does not inform any cell ID.

According to an embodiment of the present disclosure, a network node configured to operate in a wireless communication system comprises: at least one transceiver; at least one processor; and at least one memory operatively coupled to the at least one processor and storing instructions that, based on being executed by the at least one processor, perform operations comprising: transmitting, to a user equipment (UE), a radio resource control (RRC) message comprising access configurations for one or more target cells; performing a handover of the network node from a source node to a target node; and based on detecting a failure of the handover, transmitting, to the UE, an indication, wherein the indication comprises access information, wherein the UE is configured to perform an access to a target cell based on an access configuration for the target cell in the RRC message and the access information in the indication, wherein the access information comprises at least one of a random access preamble for the access or a target cell information for the access, and wherein the target cell information i) informs a cell ID of a target cell not included in the one or more target cells configured for the UE, or ii) does not inform any cell ID.

According to an embodiment of the present disclosure, a method performed by a network node configured to operate in a wireless communication system comprises: transmitting, to a user equipment (UE), a radio resource control (RRC) message comprising access configurations for one or more target cells; performing a handover of the network node from a source node to a target node; and based on detecting a failure of the handover, transmitting, to the UE, an indication, wherein the indication comprises access information, wherein the UE is configured to perform an access to a target cell based on an access configuration for the target cell in the RRC message and the access information in the indication, wherein the access information comprises at least one of a random access preamble for the access or a target cell information for the access, and wherein the target cell information i) informs a cell ID of a target cell not included in the one or more target cells configured for the UE, or ii) does not inform any cell ID.

According to an embodiment of the present disclosure, an apparatus adapted to operate in a wireless communication system comprises: at least processor; and at least one memory operatively coupled to the at least one processor and storing instructions that, based on being executed by the at least one processor, perform operations comprising: receiving, from a network node, a radio resource control (RRC) message comprising access configurations for one or more target cells; receiving, from the network node, an indication, wherein the indication comprises access information; and performing an access to a target cell based on an access configuration for the target cell in the RRC message and the access information in the indication, wherein the access information comprises at least one of a random access preamble for the access or a target cell information for the access, and wherein the target cell information i) informs a cell ID of a target cell not included in the one or more target cells configured for the UE, or ii) does not inform any cell ID.

According to an embodiment of the present disclosure, a non-transitory computer readable medium (CRM) has stored thereon a program code implementing instructions that, based on being executed by at least one processor, perform operations comprising: receiving, from a network node, a radio resource control (RRC) message comprising access configurations for one or more target cells; receiving, from the network node, an indication, wherein the indication comprises access information; and performing an access to a target cell based on an access configuration for the target cell in the RRC message and the access information in the lower layer signaling, wherein the access information comprises at least one of a random access preamble for the access or a target cell information for the access, and wherein the target cell information i) informs a cell ID of a target cell not included in the one or more target cells configured for the UE, or ii) does not inform any cell ID.

The present disclosure may have various advantageous effects.

For example, network can efficiently indicate the mobility target to be used by the UE or the random access resource to be used by the UE by using the candidate cell configuration (pre)configured by RRC and the dynamic indication indicated by the lower layer. Further, in performing mobility/RA based on dynamic indication, the UE can select the optimal mobility candidate or optimal RA resource by referring to both of the information indicated by the dynamic indication and the (pre)configured candidate cell configurations.

Advantageous effects which can be obtained through specific embodiments of the present disclosure are not limited to the advantageous effects listed above. For example, there may be a variety of technical effects that a person having ordinary skill in the related art can understand and/or derive from the present disclosure. Accordingly, the specific effects of the present disclosure are not limited to those explicitly described herein, but may include various effects that may be understood or derived from the technical features of the present disclosure.

### BRIEF DESCRIPTION OF DRAWINGS

FIG. 1 shows an example of a communication system to which implementations of the present disclosure is applied.

FIG. 2 shows an example of wireless devices to which implementations of the present disclosure is applied.

FIG. 3 shows an example of UE to which implementations of the present disclosure is applied.

FIGS. 4 and 5 show an example of protocol stacks in a 3GPP based wireless communication system to which implementations of the present disclosure is applied.

FIG. 6 shows a frame structure in a 3GPP based wireless communication system to which implementations of the present disclosure is applied.

FIG. 7 shows a data flow example in the 3GPP NR system to which implementations of the present disclosure is applied.

FIG. 8 shows an example of a legacy handover procedure to which technical features of the present disclosure can be applied.

FIG. 9 shows an example of a conditional handover procedure to which technical features of the present disclosure can be applied.

FIG. 10 shows an example of JAB topology to which technical features of the present disclosure can be applied.

FIG. 11 shows a parent and child node relationship for JAB node to which technical features of the present disclosure can be applied.

FIG. 12 shows an example of an inter-donor handover failure according to an embodiment of the present disclosure.

FIG. 13 shows an example of a method performed by a UE according to an embodiment of the present disclosure.

FIG. 14 shows an example of a method performed by a network node according to an embodiment of the present disclosure.

FIG. 15 shows an example of a signal flow for mobility based on RRC and lower layer signalling according to an embodiment of the present disclosure.

### DETAILED DESCRIPTION

The following techniques, apparatuses, and systems may be applied to a variety of wireless multiple access systems. Examples of the multiple access systems include a Code Division Multiple Access (CDMA) system, a Frequency Division Multiple Access (FDMA) system, a Time Division Multiple Access (TDMA) system, an Orthogonal Frequency Division Multiple Access (OFDMA) system, a Single Carrier Frequency Division Multiple Access (SC-FDMA) system, and a Multi Carrier Frequency Division Multiple Access (MC-FDMA) system. CDMA may be embodied through radio technology such as Universal Terrestrial Radio Access (UTRA) or CDMA2000. TDMA may be embodied through radio technology such as Global System for Mobile communications (GSM), General Packet Radio Service (GPRS), or Enhanced Data rates for GSM Evolution (EDGE). OFDMA may be embodied through radio technology such as Institute of Electrical and Electronics Engineers (IEEE) 802.11 (Wi-Fi), IEEE 802.16 (WiMAX), IEEE 802.20, or Evolved UTRA (E-UTRA). UTRA is a part of a Universal Mobile Telecommunications System (UMTS). 3rd Generation Partnership Project (3GPP) Long-Term Evolution (LTE) is a part of Evolved UMTS (E-UMTS) using E-UTRA. 3GPP LTE employs OFDMA in downlink (DL) and SC-FDMA in uplink (UL). Evolution of 3GPP LTE includes LTE-Advanced (LTE-A), LTE-A Pro, and/or 5G New Radio (NR).

For convenience of description, implementations of the present disclosure are mainly described in regards to a 3GPP based wireless communication system. However, the technical features of the present disclosure are not limited thereto. For example, although the following detailed description is given based on a mobile communication system corresponding to a 3GPP based wireless communication system, aspects of the present disclosure that are not limited to 3GPP based wireless communication system are applicable to other mobile communication systems.

For terms and technologies which are not specifically described among the terms of and technologies employed in the present disclosure, the wireless communication standard documents published before the present disclosure may be referenced.

In the present disclosure, “A or B” may mean “only A”, “only B”, or “both A and B”. In other words, “A or B” in the present disclosure may be interpreted as “A and/or B”. For example, “A, B or C” in the present disclosure may mean “only A”, “only B”, “only C”, or “any combination of A, B and C”.

In the present disclosure, slash (/) or comma (,) may mean “and/or”. For example, “A/B” may mean “A and/or B”. Accordingly, “A/B” may mean “only A”, “only B”, or “both A and B”. For example, “A, B, C” may mean “A, B or C”.

In the present disclosure, “at least one of A and B” may mean “only A”, “only B” or “both A and B”. In addition, the expression “at least one of A or B” or “at least one of A and/or B” in the present disclosure may be interpreted as same as “at least one of A and B”.

In addition, in the present disclosure, “at least one of A, B and C” may mean “only A”, “only B”, “only C”, or “any combination of A, B and C”. In addition, “at least one of A, B or C” or “at least one of A, B and/or C” may mean “at least one of A, B and C”.

Also, parentheses used in the present disclosure may mean “for example”. In detail, when it is shown as “control information (PDCCH)”, “PDCCH” may be proposed as an example of “control information”. In other words, “control information” in the present disclosure is not limited to “PDCCH”, and “PDCCH” may be proposed as an example of “control information”. In addition, even when shown as “control information (i.e., PDCCH)”, “PDCCH” may be proposed as an example of “control information”.

Technical features that are separately described in one drawing in the present disclosure may be implemented separately or simultaneously.

Although not limited thereto, various descriptions, functions, procedures, suggestions, methods and/or operational flowcharts of the present disclosure disclosed herein can be applied to various fields requiring wireless communication and/or connection (e.g., 5G) between devices.

Hereinafter, the present disclosure will be described in more detail with reference to drawings. The same reference numerals in the following drawings and/or descriptions may refer to the same and/or corresponding hardware blocks, software blocks, and/or functional blocks unless otherwise indicated.

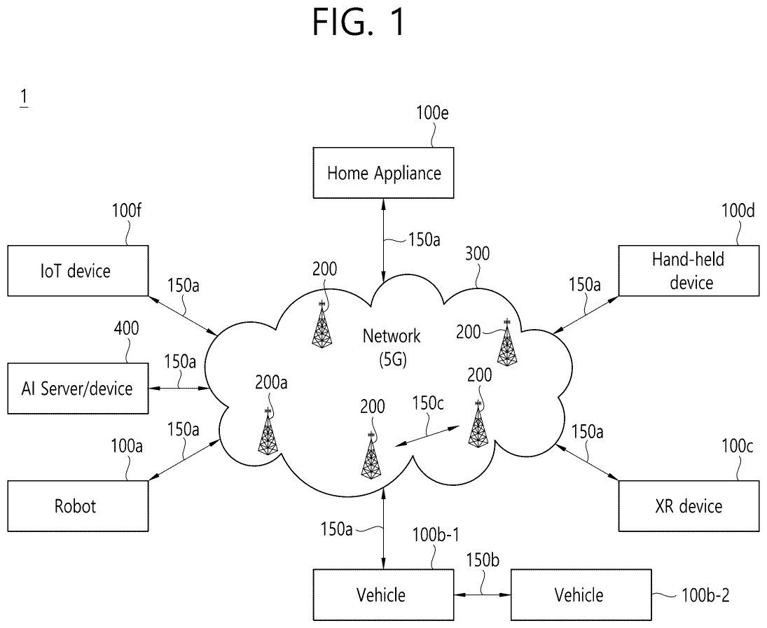

FIG. 1 shows an example of a communication system to which implementations of the present disclosure is applied.

The 5G usage scenarios shown in FIG. 1 are only exemplary, and the technical features of the present disclosure can be applied to other 5G usage scenarios which are not shown in FIG. 1.

Three main requirement categories for 5G include (1) a category of enhanced Mobile BroadBand (eMBB), (2) a category of massive Machine Type Communication (mMTC), and (3) a category of Ultra-Reliable and Low Latency Communications (URLLC).

Referring to FIG. 1, the communication system 1 includes wireless devices 100a to 100f, Base Stations (BSs) 200, and a network 300. Although FIG. 1 illustrates a 5G network as an example of the network of the communication system 1, the implementations of the present disclosure are not limited to the 5G system, and can be applied to the future communication system beyond the 5G system.

The BSs 200 and the network 300 may be implemented as wireless devices and a specific wireless device may operate as a BS/network node with respect to other wireless devices.

The wireless devices 100a to 100f represent devices performing communication using Radio Access Technology (RAT) (e.g., 5G NR or LTE) and may be referred to as communication/radio/5G devices. The wireless devices 100a to 100f may include, without being limited to, a robot 100a, vehicles 100b-1 and 100b-2, an eXtended Reality (XR) device 100c, a hand-held device 100d, a home appliance 100e, an Internet-of-Things (IoT) device 100f, and an Artificial Intelligence (AI) device/server 400. For example, the vehicles may include a vehicle having a wireless communication function, an autonomous driving vehicle, and a vehicle capable of performing communication between vehicles. The vehicles may include an Unmanned Aerial Vehicle (UAV) (e.g., a drone). The XR device may include an Augmented Reality (AR)/Virtual Reality (VR)/Mixed Reality (MR) device and may be implemented in the form of a Head-Mounted Device (HMD), a Head-Up Display (HUD) mounted in a vehicle, a television, a smartphone, a computer, a wearable device, a home appliance device, a digital signage, a vehicle, a robot, etc. The hand-held device may include a smartphone, a smartpad, a wearable device (e.g., a smartwatch or a smartglasses), and a computer (e.g., a notebook). The home appliance may include a TV, a refrigerator, and a washing machine. The IoT device may include a sensor and a smartmeter.

In the present disclosure, the wireless devices 100a to 100f may be called User Equipments (UEs). A UE may include, for example, a cellular phone, a smartphone, a laptop computer, a digital broadcast terminal, a Personal Digital Assistant (PDA), a Portable Multimedia Player (PMP), a navigation system, a slate Personal Computer (PC), a tablet PC, an ultrabook, a vehicle, a vehicle having an autonomous traveling function, a connected car, an UAV, an AI module, a robot, an AR device, a VR device, an MR device, a hologram device, a public safety device, an MTC device, an IoT device, a medical device, a FinTech device (or a financial device), a security device, a weather/environment device, a device related to a 5G service, or a device related to a fourth industrial revolution field.

The wireless devices 100a to 100f may be connected to the network 300 via the BSs 200. An AI technology may be applied to the wireless devices 100a to 100f and the wireless devices 100a to 100f may be connected to the AI server 400 via the network 300. The network 300 may be configured using a 3G network, a 4G (e.g., LTE) network, a 5G (e.g., NR) network, and a beyond-5G network. Although the wireless devices 100a to 100f may communicate with each other through the BSs 200/network 300, the wireless devices 100a to 100f may perform direct communication (e.g., sidelink communication) with each other without passing through the BSs 200/network 300. For example, the vehicles 100b-1 and 100b-2 may perform direct communication (e.g., Vehicle-to-Vehicle (V2V)/Vehicle-to-everything (V2X) communication). The IoT device (e.g., a sensor) may perform direct communication with other IoT devices (e.g., sensors) or other wireless devices 100a to 100f.

Wireless communication/connections 150a, 150b and 150c may be established between the wireless devices 100a to 100f and/or between wireless device 100a to 100f and BS 200 and/or between BSs 200. Herein, the wireless communication/connections may be established through various RATs (e.g., 5GNR) such as uplink/downlink communication 150a, sidelink communication (or Device-to-Device (D2D) communication) 150b, inter-base station communication 150c (e.g., relay, Integrated Access and Backhaul (IAB)), etc. The wireless devices 100a to 100f and the BSs 200/the wireless devices 100a to 100f may transmit/receive radio signals to/from each other through the wireless communication/connections 150a, 150b and 150c. For example, the wireless communication/connections 150a, 150b and 150c may transmit/receive signals through various physical channels. To this end, at least a part of various configuration information configuring processes, various signal processing processes (e.g., channel encoding/decoding, modulation/demodulation, and resource mapping/de-mapping), and resource allocating processes, for transmitting/receiving radio signals, may be performed based on the various proposals of the present disclosure.

NR supports multiples numerologies (and/or multiple Sub-Carrier Spacings (SCS)) to support various 5G services. For example, if SCS is 15 kHz, wide area can be supported in traditional cellular bands, and if SCS is 30 kHz/60 kHz, dense-urban, lower latency, and wider carrier bandwidth can be supported. If SCS is 60 kHz or higher, bandwidths greater than 24.25 GHz can be supported to overcome phase noise.

The NR frequency band may be defined as two types of frequency range, i.e., Frequency Range 1 (FR1) and Frequency Range 2 (FR2). The numerical value of the frequency range may be changed. For example, the frequency ranges of the two types (FR1 and FR2) may be as shown in Table 1 below. For ease of explanation, in the frequency ranges used in the NR system, FR1 may mean “sub 6 GHz range”, FR2 may mean “above 6 GHz range,” and may be referred to as millimeter Wave (mmW).

TABLE 1

| Frequency Range | Corresponding | |
|---|---|---|
| designation | frequency range | Subcarrier Spacing |
| FR1 | 450 MHz-6000 MHz | 15, 30, 60 kHz |
| FR2 | 24250 MHz-52600 MHz | 60, 120, 240 kHz |

As mentioned above, the numerical value of the frequency range of the NR system may be changed. For example, FR1 may include a frequency band of 410 MHz to 7125 MHz as shown in Table 2 below. That is, FR1 may include a frequency band of 6 GHz (or 5850, 5900, 5925 MHz, etc.) or more. For example, a frequency band of 6 GHz (or 5850, 5900, 5925 MHz, etc.) or more included in FR1 may include an unlicensed band. Unlicensed bands may be used for a variety of purposes, for example for communication for vehicles (e.g., autonomous driving).

TABLE 2

| Frequency Range | Corresponding | |
|---|---|---|
| designation | frequency range | Subcarrier Spacing |
| FR1 | 410 MHz-7125 MHz | 15, 30, 60 kHz |
| FR2 | 24250 MHz-52600 MHz | 60, 120, 240 kHz |

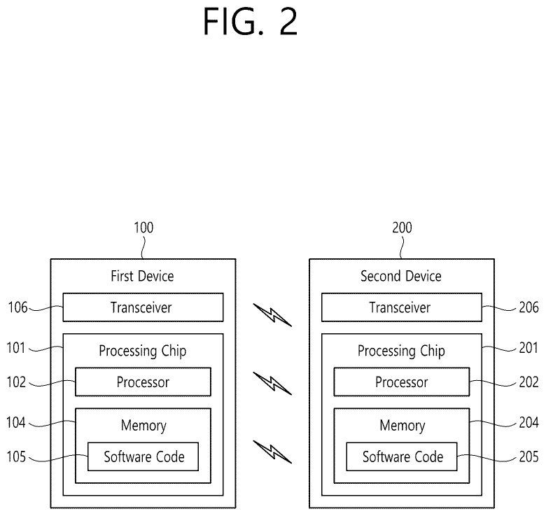

Here, the radio communication technologies implemented in the wireless devices in the present disclosure may include NarrowBand IoT (NB-IoT) technology for low-power communication as well as LTE, NR and 6G. For example, NB-IoT technology may be an example of Low Power Wide Area Network (LPWAN) technology, may be implemented in specifications such as LTE Cat NB1 and/or LTE Cat NB2, and may not be limited to the above-mentioned names. Additionally and/or alternatively, the radio communication technologies implemented in the wireless devices in the present disclosure may communicate based on LTE-M technology. For example, LTE-M technology may be an example of LPWAN technology and be called by various names such as enhanced MTC (eMTC). For example, LTE-M technology may be implemented in at least one of the various specifications, such as 1) LTE Cat 0, 2) LTE Cat M1, 3) LTE Cat M2, 4) LTE non-bandwidth limited (non-BL), 5) LTE-MTC, 6) LTE Machine Type Communication, and/or 7) LTE M, and may not be limited to the above-mentioned names. Additionally and/or alternatively, the radio communication technologies implemented in the wireless devices in the present disclosure may include at least one of ZigBee, Bluetooth, and/or LPWAN which take into account low-power communication, and may not be limited to the above-mentioned names. For example, ZigBee technology may generate Personal Area Networks (PANs) associated with small/low-power digital communication based on various specifications such as IEEE 802.15.4 and may be called various names. FIG. 2 shows an example of wireless devices to which implementations of the present disclosure is applied.

In FIG. 2, The first wireless device 100 and/or the second wireless device 200 may be implemented in various forms according to use cases/services. For example, {the first wireless device 100 and the second wireless device 200} may correspond to at least one of {the wireless device 100a to 100f and the BS 200}, {the wireless device 100a to 100f and the wireless device 100a to 100f} and/or {the BS 200 and the BS 200} of FIG. 1. The first wireless device 100 and/or the second wireless device 200 may be configured by various elements, devices/parts, and/or modules.

The first wireless device 100 may include at least one transceiver, such as a transceiver 106, at least one processing chip, such as a processing chip 101, and/or one or more antennas 108.

The processing chip 101 may include at least one processor, such a processor 102, and at least one memory, such as a memory 104. Additional and/or alternatively, the memory 104 may be placed outside of the processing chip 101.

The processor 102 may control the memory 104 and/or the transceiver 106 and may be adapted to implement the descriptions, functions, procedures, suggestions, methods and/or operational flowcharts described in the present disclosure. For example, the processor 102 may process information within the memory 104 to generate first information/signals and then transmit radio signals including the first information/signals through the transceiver 106. The processor 102 may receive radio signals including second information/signals through the transceiver 106 and then store information obtained by processing the second information/signals in the memory 104.

The memory 104 may be operably connectable to the processor 102. The memory 104 may store various types of information and/or instructions. The memory 104 may store a firmware and/or a software code 105 which implements codes, commands, and/or a set of commands that, when executed by the processor 102, perform the descriptions, functions, procedures, suggestions, methods and/or operational flowcharts disclosed in the present disclosure. For example, the firmware and/or the software code 105 may implement instructions that, when executed by the processor 102, perform the descriptions, functions, procedures, suggestions, methods and/or operational flowcharts disclosed in the present disclosure. For example, the firmware and/or the software code 105 may control the processor 102 to perform one or more protocols. For example, the firmware and/or the software code 105 may control the processor 102 to perform one or more layers of the radio interface protocol.

Herein, the processor 102 and the memory 104 may be a part of a communication modem/circuit/chip designed to implement RAT (e.g., LTE or NR). The transceiver 106 may be connected to the processor 102 and transmit and/or receive radio signals through one or more antennas 108. Each of the transceiver 106 may include a transmitter and/or a receiver. The transceiver 106 may be interchangeably used with Radio Frequency (RF) unit(s). In the present disclosure, the first wireless device 100 may represent a communication modem/circuit/chip.

The second wireless device 200 may include at least one transceiver, such as a transceiver 206, at least one processing chip, such as a processing chip 201, and/or one or more antennas 208.

The processing chip 201 may include at least one processor, such a processor 202, and at least one memory, such as a memory 204. Additional and/or alternatively, the memory 204 may be placed outside of the processing chip 201.

The processor 202 may control the memory 204 and/or the transceiver 206 and may be adapted to implement the descriptions, functions, procedures, suggestions, methods and/or operational flowcharts described in the present disclosure. For example, the processor 202 may process information within the memory 204 to generate third information/signals and then transmit radio signals including the third information/signals through the transceiver 206. The processor 202 may receive radio signals including fourth information/signals through the transceiver 106 and then store information obtained by processing the fourth information/signals in the memory 204.

The memory 204 may be operably connectable to the processor 202. The memory 204 may store various types of information and/or instructions. The memory 204 may store a firmware and/or a software code 205 which implements codes, commands, and/or a set of commands that, when executed by the processor 202, perform the descriptions, functions, procedures, suggestions, methods and/or operational flowcharts disclosed in the present disclosure. For example, the firmware and/or the software code 205 may implement instructions that, when executed by the processor 202, perform the descriptions, functions, procedures, suggestions, methods and/or operational flowcharts disclosed in the present disclosure. For example, the firmware and/or the software code 205 may control the processor 202 to perform one or more protocols. For example, the firmware and/or the software code 205 may control the processor 202 to perform one or more layers of the radio interface protocol.

Herein, the processor 202 and the memory 204 may be a part of a communication modem/circuit/chip designed to implement RAT (e.g., LTE or NR). The transceiver 206 may be connected to the processor 202 and transmit and/or receive radio signals through one or more antennas 208. Each of the transceiver 206 may include a transmitter and/or a receiver. The transceiver 206 may be interchangeably used with RF unit. In the present disclosure, the second wireless device 200 may represent a communication modem/circuit/chip.

Hereinafter, hardware elements of the wireless devices 100 and 200 will be described more specifically. One or more protocol layers may be implemented by, without being limited to, one or more processors 102 and 202. For example, the one or more processors 102 and 202 may implement one or more layers (e.g., functional layers such as Physical (PHY) layer, Media Access Control (MAC) layer, Radio Link Control (RLC) layer, Packet Data Convergence Protocol (PDCP) layer, Radio Resource Control (RRC) layer, and Service Data Adaptation Protocol (SDAP) layer). The one or more processors 102 and 202 may generate one or more Protocol Data Units (PDUs), one or more Service Data Unit (SDUs), messages, control information, data, or information according to the descriptions, functions, procedures, suggestions, methods and/or operational flowcharts disclosed in the present disclosure. The one or more processors 102 and 202 may generate signals (e.g., baseband signals) including PDUs, SDUs, messages, control information, data, or information according to the descriptions, functions, procedures, suggestions, methods and/or operational flowcharts disclosed in the present disclosure and provide the generated signals to the one or more transceivers 106 and 206. The one or more processors 102 and 202 may receive the signals (e.g., baseband signals) from the one or more transceivers 106 and 206 and acquire the PDUs, SDUs, messages, control information, data, or information according to the descriptions, functions, procedures, suggestions, methods and/or operational flowcharts disclosed in the present disclosure.

The one or more processors 102 and 202 may be referred to as controllers, microcontrollers, microprocessors, or microcomputers. The one or more processors 102 and 202 may be implemented by hardware, firmware, software, or a combination thereof. As an example, one or more Application Specific Integrated Circuits (ASICs), one or more Digital Signal Processors (DSPs), one or more Digital Signal Processing Devices (DSPDs), one or more Programmable Logic Devices (PLDs), or one or more Field Programmable Gate Arrays (FPGAs) may be included in the one or more processors 102 and 202. For example, the one or more processors 102 and 202 may be configured by a set of a communication control processor, an Application Processor (AP), an Electronic Control Unit (ECU), a Central Processing Unit (CPU), a Graphic Processing Unit (GPU), and a memory control processor.

The one or more memories 104 and 204 may be connected to the one or more processors 102 and 202 and store various types of data, signals, messages, information, programs, code, instructions, and/or commands. The one or more memories 104 and 204 may be configured by Random Access Memory (RAM), Dynamic RAM (DRAM), Read-Only Memory (ROM), electrically Erasable Programmable Read-Only Memory (EPROM), flash memory, volatile memory, non-volatile memory, hard drive, register, cash memory, computer-readable storage medium, and/or combinations thereof. The one or more memories 104 and 204 may be located at the interior and/or exterior of the one or more processors 102 and 202. The one or more memories 104 and 204 may be connected to the one or more processors 102 and 202 through various technologies such as wired or wireless connection.

The one or more transceivers 106 and 206 may transmit user data, control information, and/or radio signals/channels, mentioned in the descriptions, functions, procedures, suggestions, methods and/or operational flowcharts disclosed in the present disclosure, to one or more other devices. The one or more transceivers 106 and 206 may receive user data, control information, and/or radio signals/channels, mentioned in the descriptions, functions, procedures, suggestions, methods and/or operational flowcharts disclosed in the present disclosure, from one or more other devices. For example, the one or more transceivers 106 and 206 may be connected to the one or more processors 102 and 202 and transmit and receive radio signals. For example, the one or more processors 102 and 202 may perform control so that the one or more transceivers 106 and 206 may transmit user data, control information, or radio signals to one or more other devices. The one or more processors 102 and 202 may perform control so that the one or more transceivers 106 and 206 may receive user data, control information, or radio signals from one or more other devices.

The one or more transceivers 106 and 206 may be connected to the one or more antennas 108 and 208. Additionally and/or alternatively, the one or more transceivers 106 and 206 may include one or more antennas 108 and 208. The one or more transceivers 106 and 206 may be adapted to transmit and receive user data, control information, and/or radio signals/channels, mentioned in the descriptions, functions, procedures, suggestions, methods and/or operational flowcharts disclosed in the present disclosure, through the one or more antennas 108 and 208. In the present disclosure, the one or more antennas 108 and 208 may be a plurality of physical antennas or a plurality of logical antennas (e.g., antenna ports).

The one or more transceivers 106 and 206 may convert received user data, control information, radio signals/channels, etc., from RF band signals into baseband signals in order to process received user data, control information, radio signals/channels, etc., using the one or more processors 102 and 202. The one or more transceivers 106 and 206 may convert the user data, control information, radio signals/channels, etc., processed using the one or more processors 102 and 202 from the base band signals into the RF band signals. To this end, the one or more transceivers 106 and 206 may include (analog) oscillators and/or filters. For example, the one or more transceivers 106 and 206 can up-convert OFDM baseband signals to OFDM signals by their (analog) oscillators and/or filters under the control of the one or more processors 102 and 202 and transmit the up-converted OFDM signals at the carrier frequency. The one or more transceivers 106 and 206 may receive OFDM signals at a carrier frequency and down-convert the OFDM signals into OFDM baseband signals by their (analog) oscillators and/or filters under the control of the one or more processors 102 and 202.

Although not shown in FIG. 2, the wireless devices 100 and 200 may further include additional components. The additional components 140 may be variously configured according to types of the wireless devices 100 and 200. For example, the additional components 140 may include at least one of a power unit/battery, an Input/Output (I/O) device (e.g., audio I/O port, video I/O port), a driving device, and a computing device. The additional components 140 may be coupled to the one or more processors 102 and 202 via various technologies, such as a wired or wireless connection.

In the implementations of the present disclosure, a UE may operate as a transmitting device in Uplink (UL) and as a receiving device in Downlink (DL). In the implementations of the present disclosure, a BS may operate as a receiving device in UL and as a transmitting device in DL. Hereinafter, for convenience of description, it is mainly assumed that the first wireless device 100 acts as the UE, and the second wireless device 200 acts as the BS. For example, the processor(s) 102 connected to, mounted on or launched in the first wireless device 100 may be adapted to perform the UE behavior according to an implementation of the present disclosure or control the transceiver(s) 106 to perform the UE behavior according to an implementation of the present disclosure. The processor(s) 202 connected to, mounted on or launched in the second wireless device 200 may be adapted to perform the BS behavior according to an implementation of the present disclosure or control the transceiver(s) 206 to perform the BS behavior according to an implementation of the present disclosure.

In the present disclosure, a BS is also referred to as a node B (NB), an eNode B (eNB), or a gNB.

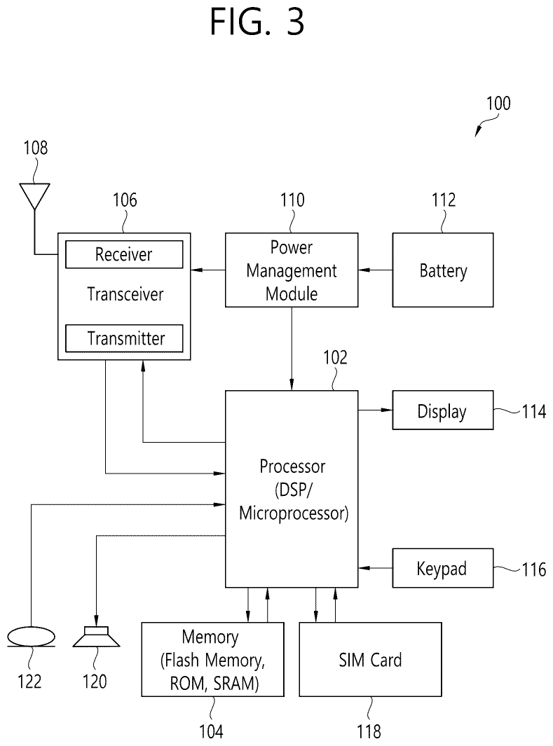

FIG. 3 shows an example of UE to which implementations of the present disclosure is applied.

Referring to FIG. 3, a UE 100 may correspond to the first wireless device 100 of FIG. 2.

A UE 100 includes a processor 102, a memory 104, a transceiver 106, one or more antennas 108, a power management module 141, a battery 142, a display 143, a keypad 144, a Subscriber Identification Module (SIM) card 145, a speaker 146, and a microphone 147.

The processor 102 may be adapted to implement the descriptions, functions, procedures, suggestions, methods and/or operational flowcharts disclosed in the present disclosure. The processor 102 may be adapted to control one or more other components of the UE 100 to implement the descriptions, functions, procedures, suggestions, methods and/or operational flowcharts disclosed in the present disclosure. Layers of the radio interface protocol may be implemented in the processor 102. The processor 102 may include ASIC, other chipset, logic circuit and/or data processing device. The processor 102 may be an application processor. The processor 102 may include at least one of DSP, CPU, GPU, a modem (modulator and demodulator). An example of the processor 102 may be found in SNAPDRAGON™ series of processors made by Qualcomm®, EXYNOS™ series of processors made by Samsung®, A series of processors made by Apple®, HELIO™ series of processors made by MediaTek®, ATOM™ series of processors made by Intel® or a corresponding next generation processor.

The memory 104 is operatively coupled with the processor 102 and stores a variety of information to operate the processor 102. The memory 104 may include ROM, RAM, flash memory, memory card, storage medium and/or other storage device. When the embodiments are implemented in software, the techniques described herein can be implemented with modules (e.g., procedures, functions, etc.) that perform the descriptions, functions, procedures, suggestions, methods and/or operational flowcharts disclosed in the present disclosure. The modules can be stored in the memory 104 and executed by the processor 102. The memory 104 can be implemented within the processor 102 or external to the processor 102 in which case those can be communicatively coupled to the processor 102 via various means as is known in the art.

The transceiver 106 is operatively coupled with the processor 102, and transmits and/or receives a radio signal. The transceiver 106 includes a transmitter and a receiver. The transceiver 106 may include baseband circuitry to process radio frequency signals. The transceiver 106 controls the one or more antennas 108 to transmit and/or receive a radio signal.

The power management module 141 manages power for the processor 102 and/or the transceiver 106. The battery 142 supplies power to the power management module 141.

The display 143 outputs results processed by the processor 102. The keypad 144 receives inputs to be used by the processor 102. The keypad 144 may be shown on the display 143.

The SIM card 145 is an integrated circuit that is intended to securely store the International Mobile Subscriber Identity (IMSI) number and its related key, which are used to identify and authenticate subscribers on mobile telephony devices (such as mobile phones and computers). It is also possible to store contact information on many SIM cards.

The speaker 146 outputs sound-related results processed by the processor 102. The microphone 147 receives sound-related inputs to be used by the processor 102.

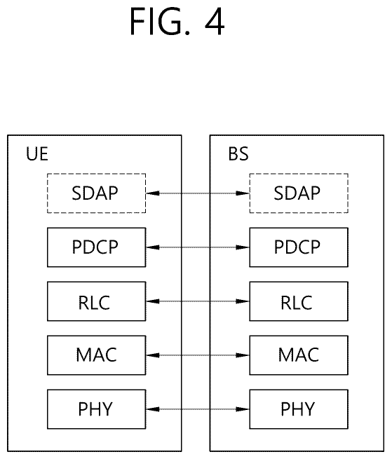

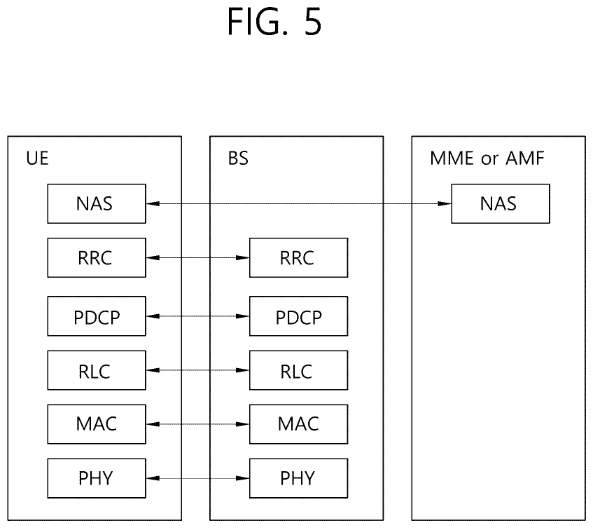

FIGS. 4 and 5 show an example of protocol stacks in a 3GPP based wireless communication system to which implementations of the present disclosure is applied.

In particular, FIG. 4 illustrates an example of a radio interface user plane protocol stack between a UE and a BS and FIG. 5 illustrates an example of a radio interface control plane protocol stack between a UE and a BS. The control plane refers to a path through which control messages used to manage call by a UE and a network are transported. The user plane refers to a path through which data generated in an application layer, for example, voice data or Internet packet data are transported. Referring to FIG. 4, the user plane protocol stack may be divided into Layer 1 (i.e., a PHY layer) and Layer 2. Referring to FIG. 5, the control plane protocol stack may be divided into Layer 1 (i.e., a PHY layer), Layer 2, Layer 3 (e.g., an RRC layer), and a non-access stratum (NAS) layer. Layer 1, Layer 2 and Layer 3 are referred to as an access stratum (AS).

In the 3GPP LTE system, the Layer 2 is split into the following sublayers: MAC, RLC, and PDCP. In the 3GPP NR system, the Layer 2 is split into the following sublayers: MAC, RLC, PDCP and SDAP. The PHY layer offers to the MAC sublayer transport channels, the MAC sublayer offers to the RLC sublayer logical channels, the RLC sublayer offers to the PDCP sublayer RLC channels, the PDCP sublayer offers to the SDAP sublayer radio bearers. The SDAP sublayer offers to 5G core network quality of service (QoS) flows.

In the 3GPP NR system, the main services and functions of the MAC sublayer include: mapping between logical channels and transport channels; multiplexing/de-multiplexing of MAC SDUs belonging to one or different logical channels into/from transport blocks (TB) delivered to/from the physical layer on transport channels; scheduling information reporting; error correction through hybrid automatic repeat request (HARQ) (one HARQ entity per cell in case of carrier aggregation (CA)); priority handling between UEs by means of dynamic scheduling; priority handling between logical channels of one UE by means of logical channel prioritization; padding. A single MAC entity may support multiple numerologies, transmission timings and cells. Mapping restrictions in logical channel prioritization control which numerology(ies), cell(s), and transmission timing(s) a logical channel can use.

Different kinds of data transfer services are offered by MAC. To accommodate different kinds of data transfer services, multiple types of logical channels are defined, i.e., each supporting transfer of a particular type of information. Each logical channel type is defined by what type of information is transferred. Logical channels are classified into two groups: control channels and traffic channels. Control channels are used for the transfer of control plane information only, and traffic channels are used for the transfer of user plane information only. Broadcast control channel (BCCH) is a downlink logical channel for broadcasting system control information, paging control channel (PCCH) is a downlink logical channel that transfers paging information, system information change notifications and indications of ongoing public warning service (PWS) broadcasts, common control channel (CCCH) is a logical channel for transmitting control information between UEs and network and used for UEs having no RRC connection with the network, and dedicated control channel (DCCH) is a point-to-point bi-directional logical channel that transmits dedicated control information between a UE and the network and used by UEs having an RRC connection. Dedicated traffic channel (DTCH) is a point-to-point logical channel, dedicated to one UE, for the transfer of user information. A DTCH can exist in both uplink and downlink. In downlink, the following connections between logical channels and transport channels exist: BCCH can be mapped to broadcast channel (BCH); BCCH can be mapped to downlink shared channel (DL-SCH); PCCH can be mapped to paging channel (PCH); CCCH can be mapped to DL-SCH; DCCH can be mapped to DL-SCH; and DTCH can be mapped to DL-SCH. In uplink, the following connections between logical channels and transport channels exist: CCCH can be mapped to uplink shared channel (UL-SCH); DCCH can be mapped to UL-SCH; and DTCH can be mapped to UL-SCH.

The RLC sublayer supports three transmission modes: transparent mode (TM), unacknowledged mode (UM), and acknowledged node (AM). The RLC configuration is per logical channel with no dependency on numerologies and/or transmission durations. In the 3GPP NR system, the main services and functions of the RLC sublayer depend on the transmission mode and include: transfer of upper layer PDUs; sequence numbering independent of the one in PDCP (UM and AM); error correction through ARQ (AM only); segmentation (AM and UM) and re-segmentation (AM only) of RLC SDUs; reassembly of SDU (AM and UM); duplicate detection (AM only); RLC SDU discard (AM and UM); RLC re-establishment; protocol error detection (AM only).

In the 3GPP NR system, the main services and functions of the PDCP sublayer for the user plane include: sequence numbering; header compression and decompression using robust header compression (ROHC); transfer of user data; reordering and duplicate detection; in-order delivery; PDCP PDU routing (in case of split bearers); retransmission of PDCP SDUs; ciphering, deciphering and integrity protection; PDCP SDU discard; PDCP re-establishment and data recovery for RLC AM; PDCP status reporting for RLC AM; duplication of PDCP PDUs and duplicate discard indication to lower layers. The main services and functions of the PDCP sublayer for the control plane include: sequence numbering; ciphering, deciphering and integrity protection; transfer of control plane data; reordering and duplicate detection; in-order delivery; duplication of PDCP PDUs and duplicate discard indication to lower layers.

In the 3GPP NR system, the main services and functions of SDAP include: mapping between a QoS flow and a data radio bearer; marking QoS flow ID (QFI) in both DL and UL packets. A single protocol entity of SDAP is configured for each individual PDU session.

In the 3GPP NR system, the main services and functions of the RRC sublayer include: broadcast of system information related to AS and NAS; paging initiated by 5 GC or NG-RAN; establishment, maintenance and release of an RRC connection between the UE and NG-RAN; security functions including key management; establishment, configuration, maintenance and release of signaling radio bearers (SRBs) and data radio bearers (DRBs); mobility functions (including: handover and context transfer, UE cell selection and reselection and control of cell selection and reselection, inter-RAT mobility); QoS management functions; UE measurement reporting and control of the reporting; detection of and recovery from radio link failure; NAS message transfer to/from NAS from/to UE.

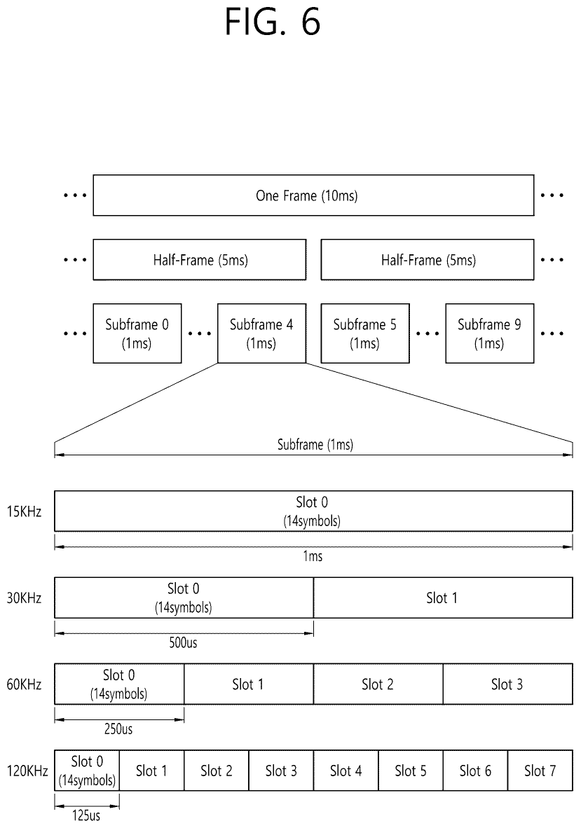

FIG. 6 shows a frame structure in a 3GPP based wireless communication system to which implementations of the present disclosure is applied.

The frame structure shown in FIG. 6 is purely exemplary and the number of subframes, the number of slots, and/or the number of symbols in a frame may be variously changed. In the 3GPP based wireless communication system, OFDM numerologies (e.g., subcarrier spacing (SCS), transmission time interval (TTI) duration) may be differently configured between a plurality of cells aggregated for one UE. For example, if a UE is configured with different SCSs for cells aggregated for the cell, an (absolute time) duration of a time resource (e.g., a subframe, a slot, or a TTI) including the same number of symbols may be different among the aggregated cells. Herein, symbols may include OFDM symbols (or CP-OFDM symbols), SC-FDMA symbols (or discrete Fourier transform-spread-OFDM (DFT-s-OFDM) symbols).

Referring to FIG. 6, downlink and uplink transmissions are organized into frames. Each frame has T_{f}=10 ms duration. Each frame is divided into two half-frames, where each of the half-frames has 5 ms duration. Each half-frame consists of 5 subframes, where the duration T_{sf} per subframe is 1 ms. Each subframe is divided into slots and the number of slots in a subframe depends on a subcarrier spacing. Each slot includes 14 or 12 OFDM symbols based on a cyclic prefix (CP). In a normal CP, each slot includes 14 OFDM symbols and, in an extended CP, each slot includes 12 OFDM symbols. The numerology is based on exponentially scalable subcarrier spacing βf=2^{u}*15 kHz.

Table 3 shows the number of OFDM symbols per slot N^{slot}_{symb}, the number of slots per frame N^{frame,u}ₛₗₒₜ, and the number of slots per subframe N^{subframe,u}ₛₗₒₜ for the normal CP, according to the subcarrier spacing βf=2^{u}*15 kHz.

TABLE 3

| u | N^{slot}_{symb} | N^{frame, u}ₛₗₒₜ | N^{subframe, u}ₛₗₒₜ |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |

Table 4 shows the number of OFDM symbols per slot N^{slot}_{symb}, the number of slots per frame N^{frame,u}ₛₗₒₜ, and the number of slots per subframe N^{subframe,u}ₛₗₒₜ for the extended CP, according to the subcarrier spacing βf=2^{u}*15 kHz.

TABLE 4

| u | N^{slot}_{symb} | N^{frame, u}ₛₗₒₜ | N^{subframe, u}ₛₗₒₜ |
|---|---|---|---|
| 2 | 12 | 40 | 4 |

A slot includes plural symbols (e.g., 14 or 12 symbols) in the time domain. For each numerology (e.g., subcarrier spacing) and carrier, a resource grid of N^{size,u}_{grid,x}*N^{RB}_{sc} subcarriers and N^{subframe,u}_{symb} OFDM symbols is defined, starting at common resource block (CRB) N^{start,u}_{grid} indicated by higher-layer signaling (e.g., RRC signaling), where N^{size,u}_{grid,x} is the number of resource blocks (RBs) in the resource grid and the subscript x is DL for downlink and UL for uplink. N^{R}_{sc} is the number of subcarriers per RB. In the 3GPP based wireless communication system, N^{R}_{sc} is 12 generally. There is one resource grid for a given antenna port p, subcarrier spacing configuration u, and transmission direction (DL or UL). The carrier bandwidth N^{size,u}_{grid} for subcarrier spacing configuration u is given by the higher-layer parameter (e.g., RRC parameter). Each element in the resource grid for the antenna port p and the subcarrier spacing configuration u is referred to as a resource element (RE) and one complex symbol may be mapped to each RE. Each RE in the resource grid is uniquely identified by an index k in the frequency domain and an index l representing a symbol location relative to a reference point in the time domain. In the 3GPP based wireless communication system, an RB is defined by 12 consecutive subcarriers in the frequency domain. As shown in FIG. 6, as SCS doubles, the slot length and symbol length are halved. For example, when SCS is 15 kHz, the slot length is 1 ms, which is the same as the subframe length. When SCS is 30 kHz, the slot length is 0.5 ms (=500 us), and the symbol length is half of that when the SCS is 15 kHz. When SCS is 60 kHz, the slot length is 0.25 ms (=250 us), and the symbol length is half of that when the SCS is 30 kHz. When SCS is 120 kHz, the slot length is 0.125 ms (=125 us), and the symbol length is half of that when the SCS is 60 kHz. When SCS is 240 kHz, the slot length is 0.0625 ms (=62.5 us), and the symbol length is half of that when the SCS is 120 kHz.

In the 3GPP NR system, RBs are classified into CRBs and physical resource blocks (PRBs). CRBs are numbered from 0 and upwards in the frequency domain for subcarrier spacing configuration u. The center of subcarrier 0 of CRB 0 for subcarrier spacing configuration u coincides with ‘point A’ which serves as a common reference point for resource block grids. In the 3GPP NR system, PRBs are defined within a bandwidth part (BWP) and numbered from 0 to N^{size}_{BWP,i}−1, where i is the number of the bandwidth part. The relation between the physical resource block n_{PRB} in the bandwidth part i and the common resource block n_{CRB} is as follows: n_{PRB}=n_{CRB}+N^{size}_{BWP,i}, where N^{size}_{BWP,i} is the common resource block where bandwidth part starts relative to CRB 0. The BWP includes a plurality of consecutive RBs. A carrier may include a maximum of N (e.g., 5) BWPs. A UE may be configured with one or more BWPs on a given component carrier. Only one BWP among BWPs configured to the UE can active at a time. The active BWP defines the UE's operating bandwidth within the cell's operating bandwidth.

In the present disclosure, the term “cell” may refer to a geographic area to which one or more nodes provide a communication system, or refer to radio resources. A “cell” as a geographic area may be understood as coverage within which a node can provide service using a carrier and a “cell” as radio resources (e.g., time-frequency resources) is associated with bandwidth which is a frequency range configured by the carrier. The “cell” associated with the radio resources is defined by a combination of downlink resources and uplink resources, for example, a combination of a DL component carrier (CC) and a UL CC. The cell may be configured by downlink resources only, or may be configured by downlink resources and uplink resources. Since DL coverage, which is a range within which the node is capable of transmitting a valid signal, and UL coverage, which is a range within which the node is capable of receiving the valid signal from the UE, depends upon a carrier carrying the signal, the coverage of the node may be associated with coverage of the “cell” of radio resources used by the node. Accordingly, the term “cell” may be used to represent service coverage of the node sometimes, radio resources at other times, or a range that signals using the radio resources can reach with valid strength at other times.

In CA, two or more CCs are aggregated. A UE may simultaneously receive or transmit on one or multiple CCs depending on its capabilities. CA is supported for both contiguous and non-contiguous CCs. When CA is configured, the UE only has one RRC connection with the network. At RRC connection establishment/re-establishment/handover, one serving cell provides the NAS mobility information, and at RRC connection re-establishment/handover, one serving cell provides the security input. This cell is referred to as the primary cell (PCell). The PCell is a cell, operating on the primary frequency, in which the UE either performs the initial connection establishment procedure or initiates the connection re-establishment procedure. Depending on UE capabilities, secondary cells (SCells) can be configured to form together with the PCell a set of serving cells. An SCell is a cell providing additional radio resources on top of special cell (SpCell). The configured set of serving cells for a UE therefore always consists of one PCell and one or more SCells. For dual connectivity (DC) operation, the term SpCell refers to the PCell of the master cell group (MCG) or the primary SCell (PSCell) of the secondary cell group (SCG). An SpCell supports PUCCH transmission and contention-based random access, and is always activated. The MCG is a group of serving cells associated with a master node, comprised of the SpCell (PCell) and optionally one or more SCells. The SCG is the subset of serving cells associated with a secondary node, comprised of the PSCell and zero or more SCells, for a UE configured with DC. For a UE in RRC_CONNECTED not configured with CA/DC, there is only one serving cell comprised of the PCell. For a UE in RRC_CONNECTED configured with CA/DC, the term “serving cells” is used to denote the set of cells comprised of the SpCell(s) and all SCells. In DC, two MAC entities are configured in a UE: one for the MCG and one for the SCG.

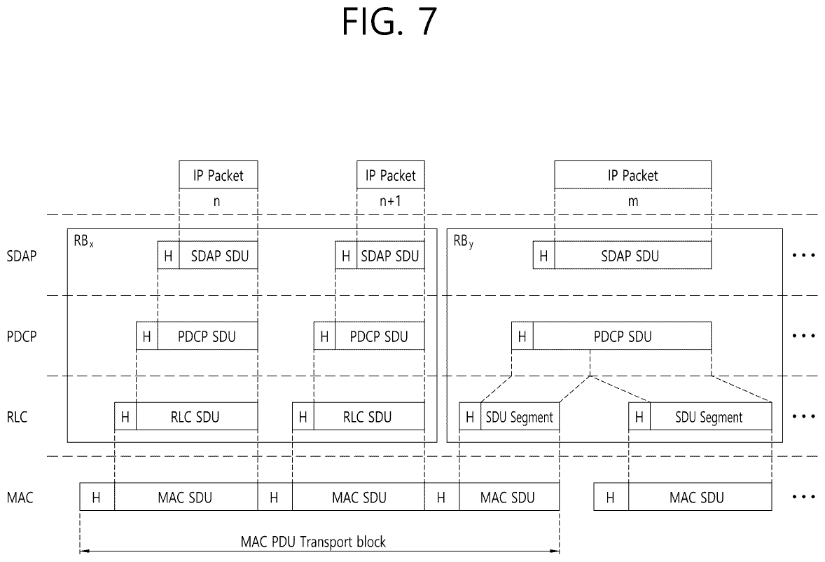

FIG. 7 shows a data flow example in the 3GPP NR system to which implementations of the present disclosure is applied.

Referring to FIG. 7, “RB” denotes a radio bearer, and “H” denotes a header. Radio bearers are categorized into two groups: DRBs for user plane data and SRBs for control plane data. The MAC PDU is transmitted/received using radio resources through the PHY layer to/from an external device. The MAC PDU arrives to the PHY layer in the form of a transport block.

In the PHY layer, the uplink transport channels UL-SCH and RACH are mapped to their physical channels physical uplink shared channel (PUSCH) and physical random access channel (PRACH), respectively, and the downlink transport channels DL-SCH, BCH and PCH are mapped to physical downlink shared channel (PDSCH), physical broadcast channel (PBCH) and PDSCH, respectively. In the PHY layer, uplink control information (UCI) is mapped to physical uplink control channel (PUCCH), and downlink control information (DCI) is mapped to physical downlink control channel (PDCCH). A MAC PDU related to UL-SCH is transmitted by a UE via a PUSCH based on an UL grant, and a MAC PDU related to DL-SCH is transmitted by a BS via a PDSCH based on a DL assignment.

Hereinafter, contents regarding handover (HO) are described.

The handover may comprise PCell change. Further, in the present disclosure, descriptions related to handover may also be applied to other mobility procedures, such as PSCell change (or, secondary node (SN) change) and/or PSCell addition (or, SN addition).

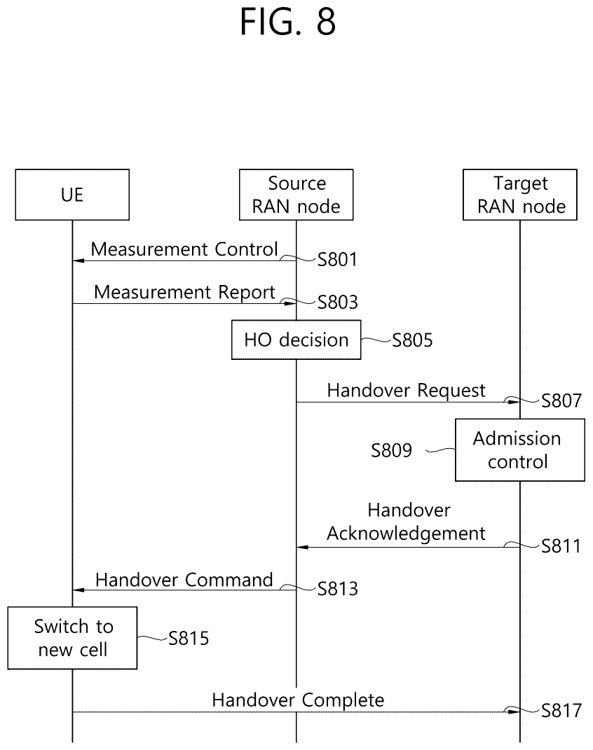

FIG. 8 shows an example of a legacy handover procedure to which technical features of the present disclosure can be applied.

Referring to FIG. 8, in step S801, the source RAN node may transmit measurement control message to the UE. The source RAN node may configure the UE measurement procedures according to the roaming and access restriction information and, for example, the available multiple frequency band information through the measurement control message. Measurement control information provided by the source RAN node through the measurement control message may assist the function controlling the UE's connection mobility. For example, the measurement control message may comprise measurement configuration and/or report configuration.

In step S803, the UE may transmit a measurement report message to the source RAN node. The measurement report message may comprise a result of measurement on neighbor cell(s) around the UE which can be detected by the UE. The UE may generate the measurement report message according to a measurement configuration and/or measurement control information in the measurement control message received in step S801.

In step S805, the source RAN node may make a handover (HO) decision based on the measurement report. For example, the source RAN node may make a HO decision and determine a target RAN node for HO among neighbor cells around the UE based on a result of measurement (e.g., cell quality, signal quality, signal strength, reference signal received power (RSRP), reference signal received quality (RSRP), channel state, channel quality, signal to interference plus noise ratio (SINR)) on the neighbor cells.

In step S807, the source RAN node may transmit a HO request message to the target RAN node which is determined in step S805. That is, the source RAN node may perform handover preparation with the target RAN node. The HO request message may comprise necessary information to prepare the handover at the target RAN node.

In step S809, the target RAN node may perform an admission control based on information included in the HO request message. The target RAN node may configure and reserve the required resources (e.g., C-RNTI and/or RACH preamble). The AS-configuration to be used in the target RAN node can either be specified independently (i.e. an “establishment”) or as a delta compared to the AS-configuration used in the source RAN node (i.e. a “reconfiguration”).

In step S811, the target RAN node may transmit a HO request acknowledge (ACK) message to the source RAN node. The HO request ACK message may comprise information on resources reserved and prepared for a handover. For example, the HO request ACK message may comprise a transparent container to be sent to the UE as an RRC message to perform the handover. The container may include a new C-RNTI, target gNB security algorithm identifiers for the selected security algorithms, a dedicated RACH preamble, and/or possibly some other parameters i.e. access parameters, SIBs. If RACH-less handover is configured, the container may include timing adjustment indication and optionally a preallocated uplink grant. The HO request ACK message may also include RNL/TNL information for forwarding tunnels, if necessary. As soon as the source RAN node receives the HO request ACK message, or as soon as the transmission of the handover command is initiated in the downlink, data forwarding may be initiated.

In step S813, the source RAN node may transmit a handover command, to the UE. For example, the handover command may comprise or may be a cell configuration (i.e., RRCReconfiguration message including the reconfigurationWithSync). The RRCReconfiguration message and/or reconfigurationWithSync for a target cell may comprise information required to access the target cell (i.e., access configuration) comprising at least one of a physical cell ID of the target cell, identifier of the UE (i.e., C-RNTI), HO validity timer (i.e., T304 timer), the target gNB security algorithm identifiers for the selected security algorithms, a set of dedicated RACH resources for contention-free random access (e.g., dedicated random access preamble), the association between RACH resources and SSB(s), the association between RACH resources and UE-specific CSI-RS configuration(s), common RACH resources, or system information of the target cell. The source RAN node may perform the necessary integrity protection and ciphering of the message.

In step S815, the UE may switch to anew cell i.e., the target RAN node. The UE may detach from the old cell i.e., the source RAN node and synchronize to anew cell i.e., the target RAN node. The UE may perform a handover from the source RAN node to the target RAN node based on applying the cell configuration. For example, upon receiving the handover command, the UE may start the T304 timer, and perform a contention-free random access towards the target RAN node based on the set of dedicated RACH resources.

In step S817, upon successful completion of the random access procedure, the UE may stop the T304 timer, and transmit a handover complete message (i.e., RRCReconfigurationComplete message) to the target RAN node. The UE may send the RRCReconfigurationComplete message comprising the C-RNTI to confirm the handover, to the target RAN node to indicate that the handover procedure is completed for the UE. The target RAN node may verify the C-RNTI sent in the RRCReconfigurationComplete message. The target RAN node can now begin sending data to the UE. When the random access fails and the T304 timer is still running, the UE may retry random access towards the target RAN node. Upon expiry of the T304 timer, the UE may declare handover failure (HOF) and perform an RRC re-establishment procedure.

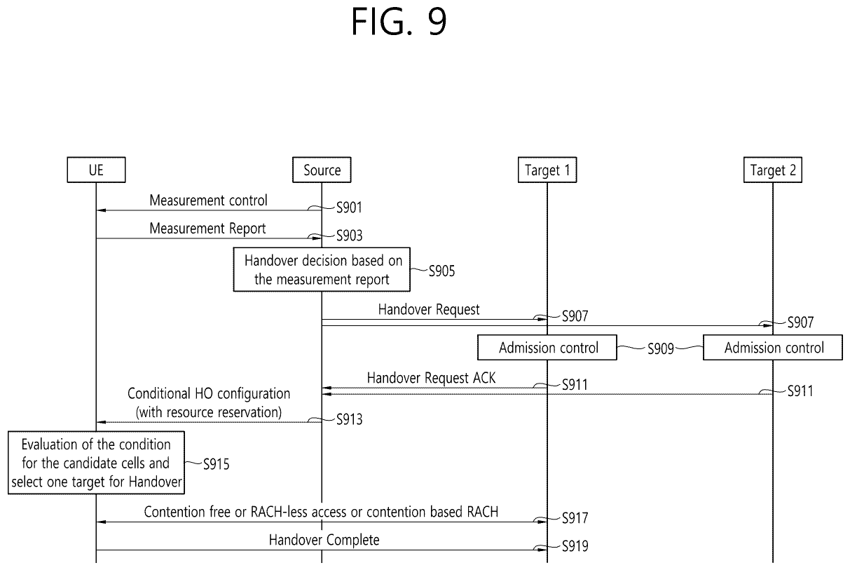

FIG. 9 shows an example of a conditional handover procedure to which technical features of the present disclosure can be applied.

Referring to FIG. 9, in step S901, the source cell may transmit measurement control message to the UE. The measurement control message may comprise a measurement configuration including a list of measurement configurations, and each measurement configuration in the list includes a measurement identity (ID), the corresponding measurement object and the corresponding report configuration.

In step S903, the UE may transmit a measurement report message to the source cell. The measurement report message may comprise a result of measurement on neighbor cell(s) around the UE which can be detected by the UE. The UE may generate the measurement report message according to a measurement configuration and/or measurement control information in the measurement control message received in step S901.

In step S905, the source cell may make a handover decision based on the measurement report. For example, the source cell may make a handover decision and determine candidate target cells (e.g., target cell 1 and target cell 2) for handover among neighbor cells around the UE based on a result of measurement (e.g., signal quality, reference signal received power (RSRP), reference signal received quality (RSRP)) on the neighbor cells.

In step S907, the source cell may transmit handover request messages to the target cell 1 and the target cell 2 which are determined in step S905. That is, the source cell may perform handover preparation with the target cell 1 and the target cell 2. The handover request message may comprise necessary information to prepare the handover at the target side (e.g., target cell 1 and target cell 2).

In step S909, each of the target cell 1 and the target cell 2 may perform an admission control based on information included in the handover request message. The target cell may configure and reserve the required resources (e.g., C-RNTI and/or RACH preamble). The AS-configuration to be used in the target cell can either be specified independently (i.e. an “establishment”) or as a delta compared to the AS-configuration used in the source cell (i.e. a “reconfiguration”).

In step S911, the target cell and the target cell 2 may transmit a handover request acknowledge (ACK) message to the source cell. The handover request ACK message may comprise cell configuration (i.e., RRCReconfiguration message including ReconfigurationWithSync) including information on resources reserved and prepared for a handover. For example, the handover request ACK message may comprise a transparent container to be sent to the UE as an RRC message (i.e., RRCReconfiguration message/cell configuration) to perform the handover. The container/cell configuration/RRCReconfiguration message may include information required to access the target cell (i.e., access configuration) comprising at least one of a physical cell ID of the target cell, identifier of the UE (i.e., C-RNTI), HO validity timer (i.e., T304 timer), the target gNB security algorithm identifiers for the selected security algorithms, a set of dedicated RACH resources for contention-free random access (e.g., dedicated random access preamble), the association between RACH resources and SSB(s), the association between RACH resources and UE-specific CSI-RS configuration(s), common RACH resources, or system information of the target cell. If RACH-less handover is configured, the container may include timing adjustment indication and optionally a preallocated uplink grant. The handover request ACK message may also include RNL/TNL information for forwarding tunnels, if necessary. As soon as the source cell receives the handover request ACK message, or as soon as the transmission of the conditional handover command is initiated in the downlink, data forwarding may be initiated.

In step S913, the source cell may transmit a RRCReconfiguration message including a conditional reconfiguration to the UE. The conditional reconfiguration may be also referred to as (or, may comprise) conditional handover (CHO) configuration and/or a conditional handover command (e.g., CHO command). The conditional reconfiguration may comprise a list of conditional reconfigurations/conditional handover commands, including a conditional reconfiguration/conditional handover command for each of the candidate target cells (e.g., target cell 1, target cell 2). For example, the conditional reconfiguration may comprise a conditional reconfiguration/conditional handover command for the target cell 1, and a conditional reconfiguration/conditional handover command for the target cell 2. The conditional reconfiguration for a target cell may comprise an index/identifier identifying the corresponding conditional reconfiguration, a handover condition for the target cell, and/or a cell configuration (i.e., RRCReconfiguration message including the reconfigurationWithSync) for the target cell. The RRCReconfiguration message and/or reconfigurationWithSync for the target cell may comprise information required to access the target cell comprising at least one of a physical cell ID of the target cell, identifier of the UE (i.e., C-RNTI), HO validity timer (i.e., T304 timer), the target gNB security algorithm identifiers for the selected security algorithms, a set of dedicated RACH resources for contention-free random access (e.g., dedicated random access preamble), the association between RACH resources and SSB(s), the association between RACH resources and UE-specific CSI-RS configuration(s), common RACH resources, or system information of the target cell.

In step S915, the UE may perform an evaluation of the handover condition for the candidate target cells (e.g., target cell 1, target cell 2) and select a target cell for a handover among the candidate target cells. For example, the UE may perform measurements on the candidate target cells, and determine whether a candidate target cell fulfils a handover condition for the candidate target cell among the candidate target cells based on a result of the measurements on the candidate target cells. Or, the UE may determine whether the target cell/measurement result for the target cell fulfils the handover condition of the target cell. If the UE identifies that the target cell 1 fulfils a handover condition for the target cell 1, the UE may select the target cell 1 as a target cell for the handover.

In step S917, the UE may detach from the old cell i.e., the source cell and synchronize to a new cell i.e., the selected target cell. The UE may perform a handover from the source cell to the target cell based on applying the cell configuration. For example, upon receiving the handover command, the UE may start the T304 timer, and perform a contention-free random access towards the target cell based on the set of dedicated RACH resources.

In step S919, upon successful completion of the random access procedure, the UE may stop the T304 timer, and transmit a handover complete message (i.e., RRCReconfigurationComplete message) to the target cell. The UE may send the RRCReconfigurationComplete message comprising the C-RNTI to confirm the handover, to the target cell to indicate that the handover procedure is completed for the UE. The target RAN node may verify the C-RNTI sent in the RRCReconfigurationComplete message. The target RAN node can now begin sending data to the UE. When the random access fails and the T304 timer is still running, the UE may retry random access towards the target cell. Upon expiry of the T304 timer, the UE may declare handover failure (HOF) and perform an RRC re-establishment procedure.

Hereinafter, contents regarding integrated access and backhaul (IAB) are described.

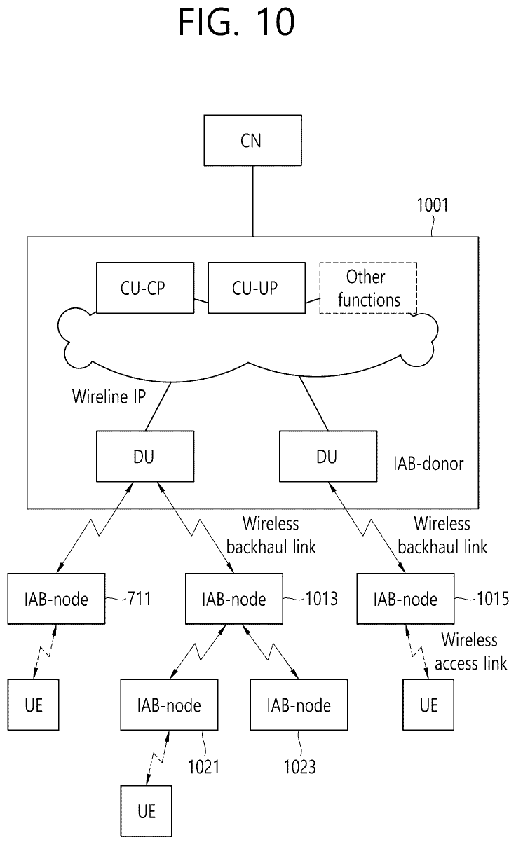

FIG. 10 shows an example of IAB topology to which technical features of the present disclosure can be applied.

Referring to FIG. 10, the IAB topology may comprise an IAB donor 1001 and multiple IAB nodes 1011, 1013, 1015, 1021 and 1023. “IAB donor node (or, simply IAB donor)” refers to a RAN node which provides UE's interface to core network (CN) and wireless backhauling functionalities to JAB nodes. The IAB donor 1001 may be treated as a signal logical node that may comprise a set of functions such as one or more distributed units (DUs), a central unit (CU) and/or potentially other functions.

The CU may be functionally split into a CU-control plane (CU-CP) and at least one CU-user plane (CU-UP).

The CU-CP may be a logical node hosting an RRC and a control plane part of a PDCP protocol of the CU for a gNB. As illustrated, the CU-CP is connected to the DU through F1-C interface. The CU-CP terminates an E1 interface connected with the CU-UP and the F1-C interface connected with the DU.

The CU-UP may be a logical node hosting a user plane part of the PDCP protocol of the CU for a gNB, and the user plane part of the PDCP protocol and a SDAP protocol of the CU for a gNB. As illustrated, the CU-UP is connected to the DU through F1-U interface, and is connected to the CU-CP through the E1 interface. The CU-UP terminates the E1 interface connected with the CU-CP and the F1-U interface connected with the DU.

In CU CP-UP split structure, the following properties may hold:

(1) A DU may be connected to a CU-CP.

(2) A CU-UP may be connected to a CU-CP.

(3) A DU can be connected to multiple CU-UPs under the control of the same CU-CP (i.e., the CU-CP to which the DU is connected and the multiple CU-UPs are connected).

(4) A CU-UP can be connected to multiple DUs under the control of the same CU-CP (i.e., the CU-CP to which the CU-UP is connected and the multiple DUs are connected).

According to various embodiments, each JAB node may comprise a set of functions including one or more distributed units (DUs), a central unit (CU) and/or potentially other functions, as well as the IAB donor.

In a deployment, the IAB donor can be split according to these functions, which can all be either collocated or non-collocated. Also, some of the functions presently associated with the IAB donor may eventually be moved outside of the IAB donor in case it becomes evident that the functions do not perform IAB-specific tasks.

The IAB donor 1001 may be connected to the JAB node 1011, 1013 and 1015 via wireless backhaul link (hereinafter, the terms “wireless backhaul link” and “wireless backhaul channel” can be used interchangeably), and may communicate with the IAB node 1011, 1013 and/or 1015 via the wireless backhaul link. For example, DUs of the IAB donor 1001 may be used to communicate with the JAB nodes 1011, 1013 and/or 1015 via wireless backhaul link. Each of the IAB node 1011 and 1015 may communicate with a UE served by itself via wireless access link (hereinafter, the term “wireless access link and wireless access channel can be used interchangeably). Further, the IAB donor 1001 may be a parent node for the IAB node 1011, 1013 and 1015, and the IAB node 1011, 1013 and 1015 may be a child node for the IAB donor 1001. The definition of the parent node and the child node will be described later.

The IAB node 1013 may be connected to IAB node 1021 and 1023 via wireless backhaul link, and may communicate with the IAB node 1021 and/or 1023 via wireless backhaul link. The IAB node 1021 may communicate with a UE served by itself via wireless access link. Further, the IAB node 1013 may be a parent node for the IAB node 1021 and 1023, and the IAB node 1021 and 1023 may be a child node for the IAB node 1013.

The IAB nodes 1011, 1013 and 1015 may directly communicate with IAB donor 1001 via wireless backhaul link. Therefore, the distance between the IAB donor 1001 and each of the IAB nodes 1011, 1013 and 1015 may be expressed as 1-hop distance. The IAB donor 1001 may be 1-hop parent node for the IAB nodes 1011, 1013 and 1015, and the IAB nodes 1011, 1013 and 1015 may be 1-hop child node for the IAB donor 1001.

The IAB nodes 1021 and 1023 may communicate with the IAB donor 1001 via a first wireless backhaul link and a second wireless backhaul link. The first wireless backhaul link may be a wireless backhaul link between i) the IAB node 1013 ii) the IAB nodes 1021 and/or 1023. The second wireless backhaul link may be a wireless backhaul link between the IAB node 1013 and the IAB donor 1001. Therefore, the distance between the IAB donor 1001 and each of the IAB nodes 1021 and 1023 may be expressed as 2-hop distance. The IAB donor 1001 may be 2-hop parent node for the IAB nodes 1021 and 1023, and the IAB nodes 1021 and 1023 may be 2-hop child node for the IAB donor 1001. In a similar way, N-hop distance may be defined between arbitrary IAB nodes (including or not including IAB donor), and thus, N-hop parent node and N-hop child node may also be defined.

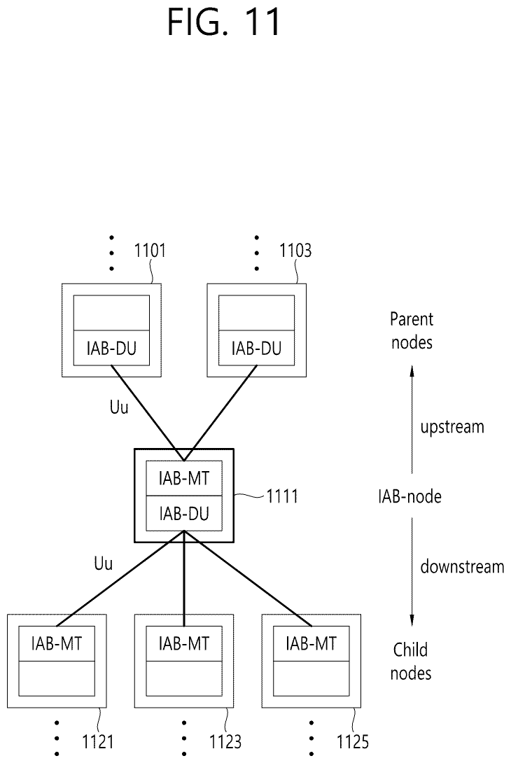

FIG. 11 shows a parent and child node relationship for IAB node to which technical features of the present disclosure can be applied.

Referring to FIG. 11, an IAB node 1111 may be connected to parent nodes 1101 and 1103 via wireless backhaul links, and may be connected to child nodes 1121, 1123 and 1125 via wireless backhaul links. Throughout the disclosure, “parent IAB node (or, simply parent node)” for an IAB node may be defined as a next hop neighbor node with respect to an IAB-mobile termination (IAB-MT, or simply MT) of the IAB node. That is, the neighbor node on the IAB-MT's interface may be referred to as a parent node. The parent node can be IAB node or IAB donor-DU. Further, “child IAB node (or, simply child node)” for an IAB node may be defined as a next hop neighbor node with respect to an IAB-DU (or, simply DU) of the IAB node. That is, the neighbor node on the IAB-DU's interface may be referred to as a child node.

IAB-MT may refer to an IAB node function that terminates the Uu interface to the parent node. IAB-DU may refer to a gNB-DU functionality supported by the IAB node to terminate the access interface to UEs and next-hop IAB nodes, and/or to terminate the F1 protocol to the gNB-CU functionality on the IAB donor.

The direction toward the child node may be referred to as downstream while the direction toward the parent node may be referred to as upstream. Further, a backhaul link between an IAB node and a parent node for the IAB node may be referred to as upward backhaul link for the IAB node. A backhaul link between an IAB node and a child node for the IAB node may be referred to as downward backhaul link for the IAB node. A backhaul link for an IAB node may comprise at least one of an upward backhaul link for the IAB node, or a downward backhaul link for the IAB node.

The IAB-node may have redundant routes to the IAB-donor CU.

For IAB-nodes operating in SA-mode, NR dual connectivity (DC) may be used to enable route redundancy in the backhaul (BH) by allowing the IAB-MT to have concurrent BH RLC links with two parent nodes. That is, an IAB node may establish a connection with a parent node which may be a master node (MN) and another parent node which may be a secondary node (SN), and utilize radio resources provided by the two parent nodes.

The parent nodes have to be connected to the same IAB-donor CU-CP, which controls the establishment and release of redundant routes via these two parent nodes. The parent nodes together with the IAB-donor CU may obtain the roles of the IAB-MT's master node and secondary node. The NR DC framework (e.g. MCG/SCG-related procedures) may be used to configure the dual radio links with the parent nodes.

In some implementations, signalling procedures related to IAB may comprise IAB-node Migration, Topological Redundancy, and/or Backhaul RLF Recovery.

### (1) IAB-Node Migration

The IAB-node can migrate to a different parent node underneath the same IAB-donor-CU. The IAB-node continues providing access and backhaul service when migrating to a different parent node.

The IAB-MT can also migrate to a different parent node underneath another IAB-donor-CU. In this case, the collocated IAB-DU and the IAB-DU(s) of its descendant node(s) retain F1 connectivity with the initial IAB-donor-CU. The IAB-MT of each descendant node and all the served UEs retain the RRC connectivity with the initial IAB-donor-CU. This migration is referred to as inter-donor partial migration. The IAB-node, whose IAB-MT migrates to the new IAB-donor-CU, is referred to as a boundary IAB-node. After inter-donor partial migration, the F1 traffic of the IAB-DU and its descendant nodes is routed via the BAP layer of the JAB topology to which the IAB-MT has migrated.

Inter-donor partial migration is only supported for SA-mode.

### (2) Topological Redundancy

The IAB-node may have redundant routes to the IAB-donor-CU(s).

For IAB-nodes operating in SA-mode, NR DC can be used to enable route redundancy in the BH by allowing the IAB-MT to have concurrent BH links with two parent nodes. The parent nodes may be connected to the same or to different IAB-donor-CUs, which control the establishment and release of redundant routes via these two parent nodes. Either parent node's gNB-DU functionality together with the respective IAB-donor-CU assumes the role of the IAB-MT's master node or secondary node. The NR DC framework (e.g., MCG/SCG-related procedures) is used to configure the dual radio links with the parent nodes.

An IAB-node operating in NR-DC may also use one of its links for BH connectivity with an IAB-donor and the other link for access-only connectivity with a separate gNB that does not assume IAB-donor role. The IAB-donor can assume the MN or the SN role. The IAB-node may exchange F1-C traffic with the IAB-donor via the backhaul link and/or via the access link with the gNB. In the latter case, the F1-C messages are carried over NR RRC between the IAB-node and the gNB, and via XnAP between the gNB and the IAB-donor.

IAB-nodes operating in EN-DC can exchange F1-C traffic with the IAB-donor via the MeNB. The F1-C message is carried over LTE RRC using SRB2 between IAB-node and MeNB and via X2AP between the MeNB and the IAB-donor.

### (3) Backhaul RLF Recovery

When the IAB-node using SA-mode declares RLF on the backhaul link, it can perform RLF recovery at another parent node underneath the same or underneath a different IAB-donor-CU. In the latter case, the collocated IAB-DU and the IAB-DU(s) of its descendant node(s) may retain the F1 connectivity with the initial IAB-donor-CU, while the IAB-MT(s) of the descendant node(s) and all the served UEs retain the RRC connectivity with the initial IAB-donor-CU, in the same manner as for inter-donor partial migration.

Meanwhile, once inter-donor handover of JAB node occurs, handovers of UEs connected to the IAB node need to be quickly triggered. If handover of UE connected to the IAB node is delayed, communication of the UEs would be interrupted in the new donor's topology until the UE is reconfigured via handover completion.

However, concurrent handovers of connected UEs may incur non-trivial HO signalling. In particular, if the number of UEs connected to the JAB node is large, the concurrent mobility results in a HO-related signalling storm due to concentration of involving AS and NAS signalling related to handovers of those UEs. Given that the handover signalling is delivered via SRBs, the signalling storm would be burdensome to network. If completions of handover of UEs are somehow delayed, UP interruption would be experienced to the UE with delayed HOs.

To minimize UP interruption caused by delayed HO completion for UEs, UEs can be (pre)configured with target cell configuration (i.e., cell configuration for a target cell) prior to the handover of the JAB node. Then, after the handover completion of the JAB node, handovers of the UEs connected to the JAB nodes can be quickly initiated with less signalling burden to network. Then, the overall completion time of handovers could be shortened.

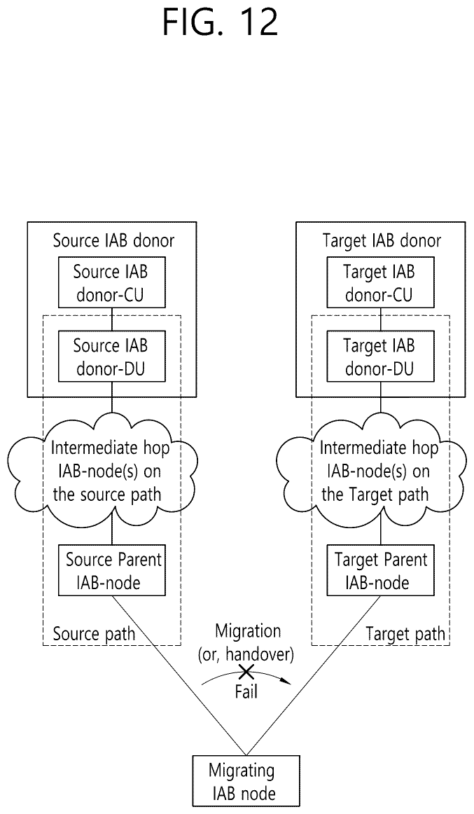

However, handover of an JAB node serving many UEs may fail, as shown in FIG. 12.

FIG. 12 shows an example of an inter-donor handover failure according to an embodiment of the present disclosure.

If handover of an IAB node serving many UEs fails, the JAB node may attempt to recover from the handover failure by initiating applicable recovery procedure e.g., re-establishment or other fast recovery mechanism such as CHO-based handover.

Until the recovery completion, the UEs connected to the JAB node do not know what has happened to the JAB node and hence experience service interruption. Fast recovery to avoid the interruption needs to be developed.

Therefore, in this disclosure, method and apparatus for fast recovery to avoid interruption of UEs connected to an JAB node in case of handover failure of the JAB node is developed.

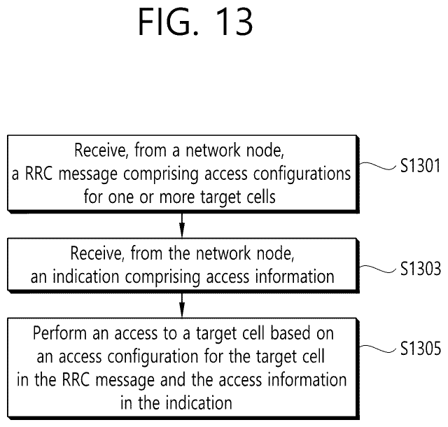

FIG. 13 shows an example of a method performed by a UE according to an embodiment of the present disclosure. The method may also be performed by a wireless device.

Referring to FIG. 13, in step S1301, the UE may receive, from a network node, a RRC message comprising access configurations for one or more target cells.

In step S1303, the UE may receive, from the network node, an indication. The indication may comprise access information. The access information may comprise at least one of a random access preamble for the access or a target cell information for the access. The target cell information i) may inform a cell ID of a target cell not included in the one or more target cells configured for the UE, or ii) does not inform any cell ID.

In step S1305, the UE may perform an access to a target cell based on an access configuration for the target cell in the RRC message and the access information in the lower layer signaling.

According to various embodiments, the indication may be received via at least one of downlink control information (DCI) on a physical downlink control channel (PDCCH) or media access control (MAC) control element (CE).

According to various embodiments, the access information may comprise the random access preamble. The UE may perform a random access procedure based on the access configuration in the RRC message. The UE may transmit the random access preamble to the network during the random access procedure.

According to various embodiments, the random access preamble may comprise a dedicated random access preamble. The random access procedure may comprise a contention-free random access procedure initiated by transmitting the dedicated random access preamble.

According to various embodiments, the access information may comprise the target cell information as a positive indicator. The information as a positive indicator may inform a cell ID of a target cell to perform the access to.

According to various embodiments, based on the target cell information as a positive indicator informing a cell ID of a target cell not included in the one or more target cells configured for the UE, the UE may determine that a radio link failure (RLF) has occurred. The UE may initiate a re-establishment procedure for recovery of the RLF. The UE may perform a cell selection during the re-establishment procedure. Based on a selected cell by the cell selection being the target cell included in the one or more target cells, the UE may perform the access to the selected target cell.

According to various embodiments, based on the target cell information as a positive indicator not informing any cell ID, the UE may determine that a radio link failure (RLF) has occurred. The UE may initiate a re-establishment procedure for recovery of the RLF. The UE may perform a cell selection during the re-establishment procedure. Based on a selected cell by the cell selection being the target cell included in the one or more target cells, the UE may perform the access to the selected target cell. According to various embodiments, the access information may comprise the target cell information as a negative indicator. The target cell information as a negative indicator may inform a cell ID of a target cell not to perform the access to.

According to various embodiments, based on the target cell information as a negative indicator informing a cell ID of a target cell not included in the one or more target cells configured for the UE, the UE may select the target cell among the or more target cells. The UE may perform the access to the selected target cell.

According to various embodiments, based on the target cell information as a negative indicator not informing any cell ID, the UE may select the target cell among the or more target cells. The UE may perform the access to the selected target cell.

According to various embodiments, the access configuration for the target cell may comprise at least one of a physical cell ID of the target cell, a cell-radio network temporary ID (C-RNTI), a T304 timer, a set of dedicated random access resources for contention-free random access, an association between random access resources and synchronization signal blocks (SSBs), an association between random access resources and UE-specific channel state information (CSI) reference signal (RS) configurations, or system information of the target cell.

According to various embodiments, the network node may comprise an integrated access and backhaul (IAB) node performing a handover from a source parent JAB node to a target parent JAB node. The indication may be received based on a failure of the handover.

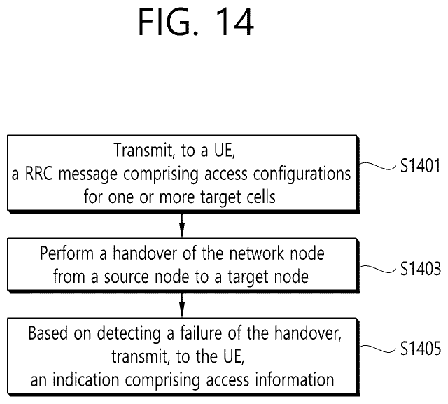

FIG. 14 shows an example of a method performed by a network node according to an embodiment of the present disclosure. The network node may comprise a base station (BS) and/or an JAB node.

Referring to FIG. 14, in step S1401, the network node may transmit, to a UE, a RRC message comprising access configurations for one or more target cells.

In step S1403, the network node may perform a handover of the network node from a source node to a target node.

In step S1405, the network node may, based on detecting a failure of the handover, transmit, to the UE, an indication. The indication may comprise access information. The access information may comprise at least one of a random access preamble for the access or a target cell information for the access. The target cell information i) may inform a cell ID of a target cell not included in the one or more target cells configured for the UE, or ii) does not inform any cell ID.

The UE may be configured to perform an access to a target cell based on an access configuration for the target cell in the RRC message and the access information in the lower layer signaling.

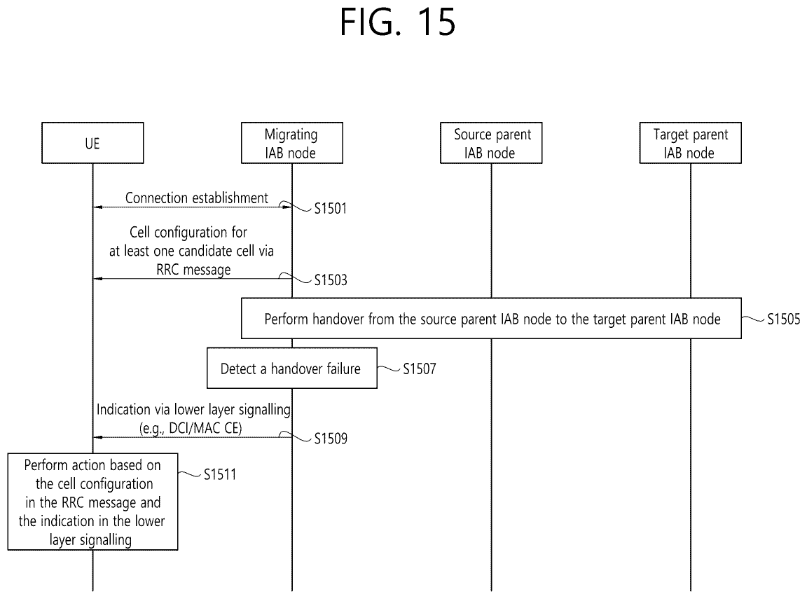

FIG. 15 shows an example of a signal flow for mobility based on RRC and lower layer signalling according to an embodiment of the present disclosure.

Referring to FIG. 15, in steps 1501, the UE may establish a connection with the migrating JAB node. One or more UEs including the UE may be connected to the one or more IAB node.

In step S1503, the UE may receive, from the migrating JAB node, an RRC message comprising cell configuration(s) for at least one candidate cell. The UE may be (pre)configured with the cell configuration(s) for the at least one candidate cell, before the migrating JAB node performs handover. The UE may store the (pre)configuration (i.e., cell configuration(s) for at least one candidate cell).

In step S1505, the migrating JAB node may perform a handover from a source parent IAB node to a target parent JAB node. The source parent JAB node may be associated with a source IAB donor, and the target parent JAB node may be associated with a target IAB donor. That is, the handover may be an inter-donor handover (i.e., full migration) between two different topologies governed by different donors.

In step S1507, the migrating JAB node may detect a handover failure.

In step S1509, if the migrating JAB node detects a handover failure, the migrating JAB node may send an indication to the connected UEs. The indication may be transmitted via L1/L2 lower layer signalling (i.e., DCI/MAC CE).

In some implementations, the indication may be transmitted via L3 signalling (i.e., RRC signalling) instead of lower layer signalling.

In some implementations, the indication may or may not include a cell ID. Cell ID related features will be further described below.

In some implementations, the indication may include random access (RA) information.

In some implementations, the indication may be transmitted in a dedicated manner. That is, each indication is transmitted to a dedicated UE by using dedicated resources for the UE.

In some implementations, the indication may be transmitted in a multicast manner. That is, each common indication is transmitted to each group of UEs by using resources dedicated for the group of UEs.

In some implementations, the indication may be transmitted in a broadcast manner. That is, the indication is transmitted to certain UEs by using common resources known to the UEs.

In step S1511, upon reception of the indication, the UE may decide/perform its action based on at least the indication and/or the (pre)configuration stored in the UE.

According to various embodiments, the cell ID may comprise at least one of a cell ID as a positive indicator, or negative indicator.

### Embodiment 1: Cell ID as Positive Indicator

In this embodiment, the cell ID may comprise a cell ID of a target cell associated with the target parent JAB node to which the migrating JAB node has attempted the handover.

If a UE receives the indication from the migrating IAB node and the UE is already configured with a cell configuration for a target cell (i.e., (pre)configured target or candidate cell) corresponding to the cell ID included in the indication, the UE may apply the cell configuration and attempt to access the target cell (i.e., executes an autonomous mobility).

If the indication includes the RA information, the UE may apply the RA information for access to the target cell. For example, if dedicated preamble ID is included in the RA information, the UE may execute the autonomous mobility by using the indicated preamble on top of RA configuration within the (pre)configuration/cell configuration for the target cell,

If a UE receives the indication from the migrating IAB node but the UE is not configured with a cell configuration for a target cell (i.e., (pre)configured target or candidate cell) corresponding to the cell ID included in the indication, the UE may consider that radio link failure (RLF) happens on its serving cell associated with a distributed unit (DU) of the migrating IAB node. Then, the UE may initiate re-establishment for recovery from the RLF (i.e., perform RRC re-establishment procedure).

If a UE receives the indication from the migrating IAB node and the UE is already configured with a cell configuration for a target cell (i.e., (pre)configured target or candidate cell) that does not match the cell ID included in the indication:
the UE may apply the cell configuration and attempt to access the target cell (i.e., executes an autonomous mobility); and/or
the UE may consider that RLF happens on the serving cell associated with a distributed unit (DU) of the migrating IAB node.

If a UE receives the indication not including a cell ID from the migrating IAB node and the UE is already configured with a cell configuration for a target cell (i.e., (pre)configured target or candidate cell):
the UE may apply the cell configuration and attempt to access the target cell (i.e., executes an autonomous mobility); and/or
the UE may consider that RLF happens on the serving cell associated with a distributed unit (DU) of the migrating IAB node.

### Embodiment 2: Cell ID as Negative Indicator

In this embodiment, the cell ID may comprise a cell ID used by recipient (i.e., UE) to avoid handover to the corresponding cell, because handover to the cell may fail again.

If a UE receives the indication from the migrating IAB node and the UE is already configured with a cell configuration for a target cell (i.e., (pre)configured target or candidate cell) not corresponding to the cell ID included in the indication, the UE may apply the cell configuration and attempt to access the target cell (i.e., executes an autonomous mobility).

If the indication includes the RA information, the UE may apply the RA information for access to the target cell. For example, if dedicated preamble ID is included in the RA information, the UE may execute the autonomous mobility by using the indicated preamble on top of RA configuration within the (pre)configuration/cell configuration for the target cell,

If a UE receives the indication from the migrating IAB node but the UE is not configured with a cell configuration for a target cell (i.e., (pre)configured target or candidate cell) not corresponding to the cell ID included in the indication, the UE may consider that radio link failure (RLF) happens on its serving cell associated with a distributed unit (DU) of the migrating IAB node. Then, the UE may initiate re-establishment for recovery from the RLF (i.e., perform RRC re-establishment procedure).

If a UE receives the indication from the migrating IAB node and the UE is already configured with only a cell configuration for a target cell (i.e., (pre)configured target or candidate cell) that matches the cell ID included in the indication:
the UE may apply the cell configuration and attempt to access the target cell (i.e., executes an autonomous mobility); and/or
the UE may consider that RLF happens on the serving cell associated with a distributed unit (DU) of the migrating IAB node.

If a UE receives the indication not including a cell ID from the migrating IAB node and the UE is already configured with a cell configuration for a target cell (i.e., (pre)configured target or candidate cell):
the UE may apply the cell configuration and attempt to access the target cell (i.e., executes an autonomous mobility); and/or
the UE may consider that RLF happens on the serving cell associated with a distributed unit (DU) of the migrating IAB node.

Furthermore, the method in perspective of the UE described in the present disclosure (e.g., in FIG. 13) may be performed by the first wireless device 100 shown in FIG. 2 and/or the UE 100 shown in FIG. 3.

More specifically, the UE comprises at least one transceiver, at least processor, and at least one computer memory operably connectable to the at least one processor and storing instructions that, based on being executed by the at least one processor, perform operations.

The operations comprise: receiving, from a network node, a radio resource control (RRC) message comprising access configurations for one or more target cells; receiving, from the network node, an indication, wherein the indication comprises access information; and performing an access to a target cell based on an access configuration for the target cell in the RRC message and the access information in the lower layer signaling, wherein the access information comprises at least one of a random access preamble for the access or a target cell information for the access, and wherein the target cell information i) informs a cell identifier (ID) of a target cell not included in the one or more target cells configured for the UE, or ii) does not inform any cell ID.

Furthermore, the method in perspective of the UE described in the present disclosure (e.g., in FIG. 13) may be performed by a software code 105 stored in the memory 104 included in the first wireless device 100 shown in FIG. 2.

More specifically, at least one computer readable medium (CRM) stores instructions that, based on being executed by at least one processor, perform operations comprising: receiving, from a network node, a radio resource control (RRC) message comprising access configurations for one or more target cells; receiving, from the network node, an indication, wherein the indication comprises access information; and performing an access to a target cell based on an access configuration for the target cell in the RRC message and the access information in the lower layer signaling, wherein the access information comprises at least one of a random access preamble for the access or a target cell information for the access, and wherein the target cell information i) informs a cell identifier (ID) of a target cell not included in the one or more target cells configured for the UE, or ii) does not inform any cell ID.

Furthermore, the method in perspective of the UE described in the present disclosure (e.g., in FIG. 13) may be performed by control of the processor 102 included in the first wireless device 100 shown in FIG. 2 and/or by control of the processor 102 included in the UE 100 shown in FIG. 3.

More specifically, an apparatus configured to/adapted to operate in a wireless communication system (e.g., wireless device/UE) comprises at least processor, and at least one computer memory operably connectable to the at least one processor. The at least one processor is configured to/adapted to perform operations comprising: receiving, from a network node, a radio resource control (RRC) message comprising access configurations for one or more target cells; receiving, from the network node, an indication, wherein the indication comprises access information; and performing an access to a target cell based on an access configuration for the target cell in the RRC message and the access information in the lower layer signaling, wherein the access information comprises at least one of a random access preamble for the access or a target cell information for the access, and wherein the target cell information i) informs a cell identifier (ID) of a target cell not included in the one or more target cells configured for the UE, or ii) does not inform any cell ID.

Furthermore, the method in perspective of a network node described in the present disclosure (e.g., in FIG. 14) may be performed by the second wireless device 200 shown in FIG. 2.

More specifically, the network node comprises at least one transceiver, at least processor, and at least one computer memory operably connectable to the at least one processor and storing instructions that, based on being executed by the at least one processor, perform operations.

The operations comprise: transmitting, to a user equipment (UE), a radio resource control (RRC) message comprising access configurations for one or more target cells; performing a handover of the network node from a source node to a target node; and based on detecting a failure of the handover, transmitting, to the UE, an indication, wherein the indication comprises access information, wherein the UE is configured to perform an access to a target cell based on an access configuration for the target cell in the RRC message and the access information in the lower layer signaling, wherein the access information comprises at least one of a random access preamble for the access or a target cell information for the access, and wherein the target cell information i) informs a cell identifier (ID) of a target cell not included in the one or more target cells configured for the UE, or ii) does not inform any cell ID.

The present disclosure may have various advantageous effects.

For example, network can efficiently indicate the mobility target to be used by the UE or the random access resource to be used by the UE by using the candidate cell configuration (pre)configured by RRC and the dynamic indication indicated by the lower layer. Further, in performing mobility/RA based on dynamic indication, the UE can select the optimal mobility candidate or optimal RA resource by referring to both of the information indicated by the dynamic indication and the (pre)configured candidate cell configurations.

Advantageous effects which can be obtained through specific embodiments of the present disclosure are not limited to the advantageous effects listed above. For example, there may be a variety of technical effects that a person having ordinary skill in the related art can understand and/or derive from the present disclosure. Accordingly, the specific effects of the present disclosure are not limited to those explicitly described herein, but may include various effects that may be understood or derived from the technical features of the present disclosure.

Claims in the present disclosure can be combined in a various way. For instance, technical features in method claims of the present disclosure can be combined to be implemented or performed in an apparatus, and technical features in apparatus claims can be combined to be implemented or performed in a method. Further, technical features in method claim(s) and apparatus claim(s) can be combined to be implemented or performed in an apparatus. Further, technical features in method claim(s) and apparatus claim(s) can be combined to be implemented or performed in a method. Other implementations are within the scope of the following claims.

1. A method comprising:
receiving, from a network node, a radio resource control (RRC) message comprising access configurations for one or more target cells;
receiving, from the network node, an indication, wherein the indication comprises access information; and
performing an access to a target cell based on an access configuration for the target cell in the RRC message and the access information in the indication,
wherein the access information comprises at least one of a random access preamble for the access or a target cell information for the access, and
wherein the target cell information i) informs a cell identifier (ID) of a target cell not included in the one or more target cells, or ii) does not inform any cell ID.

2. The method of claim 1, wherein the indication is received via at least one of downlink control information (DCI) on a physical downlink control channel (PDCCH) or media access control (MAC) control element (CE).

3. The method of claim 1, wherein the access information comprises the random access preamble,
wherein the performing of the access comprises performing a random access procedure based on the access configuration in the RRC message, and
wherein the method further comprises transmitting the random access preamble to the network during the random access procedure.

4. The method of claim 3, wherein the random access preamble comprises a dedicated random access preamble, and
wherein the random access procedure comprises a contention-free random access procedure initiated by transmitting the dedicated random access preamble.

5. The method of claim 1, wherein the access information comprises the target cell information as a positive indicator, and
wherein the target cell information as a positive indicator informs a cell ID of a target cell to perform the access to.

6. The method of claim 5, based on the target cell information as a positive indicator informing a cell ID of a target cell not included in the one or more target cells, further comprising:
determining that a radio link failure (RLF) has occurred;
initiating a re-establishment procedure for recovery of the RLF; and
performing a cell selection during the re-establishment procedure,
wherein the performing of the access comprises, based on a selected cell by the cell selection being the target cell included in the one or more target cells, performing the access to the selected target cell.

7. The method of claim 5, based on the target cell information as a positive indicator not informing any cell ID, further comprising:
determining that a radio link failure (RLF) has occurred;
initiating a re-establishment procedure for recovery of the RLF; and
performing a cell selection during the re-establishment procedure,
wherein the performing of the access comprises, based on a selected cell by the cell selection being the target cell included in the one or more target cells, performing the access to the selected target cell.

8. The method of claim 1, wherein the access information comprises the target cell information as a negative indicator, and
wherein the target cell information as a negative indicator informs a cell ID of a target cell not to perform the access to.

9. The method of claim 8, based on the target cell information as a negative indicator informing a cell ID of a target cell not included in the one or more target cells, further comprising selecting the target cell among the one or more target cells, and
wherein the performing of the access comprises performing the access to the selected target cell.

10. The method of claim 8, based on the target cell information as a negative indicator not informing any cell ID, further comprising selecting the target cell among the or more target cells, and
wherein the performing of the access comprises performing the access to the selected target cell.

11. The method of claim 1, wherein the access configuration for the target cell comprises at least one of a physical cell ID of the target cell, a cell-radio network temporary ID (C-RNTI), a T304 timer, a set of dedicated random access resources for contention-free random access, an association between random access resources and synchronization signal blocks (SSBs), an association between random access resources and user equipment (UE)-specific channel state information (CSI) reference signal (RS) configurations, or system information of the target cell.

12. The method of claim 1, wherein the network node comprises an integrated access and backhaul (IAB) node performing a handover from a source parent IAB node to a target parent IAB node, and
wherein the indication is received based on a failure of the handover.

13. The method of claim 1, wherein the method is performed by a user equipment (UE) in communication with at least one of a mobile device, a network, or autonomous vehicles.

14. A user equipment (UE) comprising:
at least one transceiver;
at least one processor; and
at least one memory operatively coupled to the at least one processor and storing instructions that, based on being executed by the at least one processor, perform operations comprising:
receiving, from a network node, a radio resource control (RRC) message comprising access configurations for one or more target cells;
receiving, from the network node, an indication, wherein the indication comprises access information; and
performing an access to a target cell based on an access configuration for the target cell in the RRC message and the access information in the indication,
wherein the access information comprises at least one of a random access preamble for the access or a target cell information for the access, and
wherein the target cell information i) informs a cell ID of a target cell not included in the one or more target cells configured for the UE, or ii) does not inform any cell ID.

15. (canceled)

16. A network node comprising:
at least one transceiver;
at least one processor; and
at least one memory operatively coupled to the at least one processor and storing instructions that, based on being executed by the at least one processor, perform operations comprising:
transmitting, to a user equipment (UE), a radio resource control (RRC) message comprising access configurations for one or more target cells;
performing a handover of the network node from a source node to a target node; and
based on detecting a failure of the handover, transmitting, to the UE, an indication,
wherein the indication comprises access information,
wherein the UE is configured to perform an access to a target cell based on an access configuration for the target cell in the RRC message and the access information in the indication,
wherein the access information comprises at least one of a random access preamble for the access or a target cell information for the access, and
wherein the target cell information i) informs a cell ID of a target cell not included in the one or more target cells configured for the UE, or ii) does not inform any cell ID.

17-20. (canceled)
